(19) United States
(12) Patent Application Publication
(10) Pub. No.: US 2006/0015424 A1
(43) Pub. Date: Jan. 19, 2006

(54) Management method, system and product for enterprise environmental programs

(75) Inventors: Patrick R. Esposito II, Morgantown, WV (US); Clint M. Harvey, Morgantown, WV (US); Michelle Varga Esposito, Morgantown, WV (US); George K. Thomas, Morgantown, WV (US); Jackie P. Williams II, Morgantown, WV (US); Jesse E. Gandee, Morgantown, WV (US); Patrick R. Esposito SR., Morgantown, WV (US); C. David Locke, Morgantown, WV (US); Janet M. Wood, Morgantown, WV (US)

Correspondence Address: BOWLES RICE MCDAVID GRAFF & LOVE LLP, POST OFFICE BOX 1386, CHARLESTON, WV, 25325-1386, US

(73) Assignee: Augusta Systems, Inc., Morgantown, WV (US)

(21) Appl. No.: 10/891,725

(22) Filed: Jul. 15, 2004

(51) Int. Cl. G06Q 40/00

(52) U.S. Cl. 705/35

(57) ABSTRACT

To provide for management of enterprise environmental programs, the invention is a method, system, and computer program product that performs functions for emissions cataloging, assessing, analyzing, comparing, strategic planning, reporting and viewing. The invention further provides an integrated, modular mechanism with dynamic data promulgation for making strategic performance assessments and investment decisions. The invention uses a plurality of databases and datastores for storing, tracking, analyzing and comparing emissions information, emissions management activity information, market information, regulatory and voluntary compliance information, risk management information, as well as financial, legal, and production information, at an entity, facility, process, and other enterprise levels. The invention further includes a user interactive feature that provides a means for the user of the invention to enter data and receive an analyzed and compared data output display from a central client server.

### BACKGROUND OF THE INVENTION

1. Field of the Invention

The present invention disclosed herein relates to a management method, system, and product for enterprise environmental programs.

2. Description of the Prior Art

In the United States and throughout the world, entities, both public and private, have begun to make reductions in certain categories and types of environmental gas emissions, and water discharges (collectively the “emissions”). While often these decisions are the result of government regulatory regimes which mandate emissions reductions, in other instances, the decisions to reduce emissions can come as a result of voluntary mechanisms that may be adopted to minimize financial risk, enhance public relations, accommodate the demands of shareholders, or stave off potentially restrictive regulatory structures. In the case of mandated regulatory measures, these mechanisms may be accompanied by emissions trading programs, which can help to ensure that these aggregate emissions management activities occur in a most cost-effective manner, and in a way that are the least potentially damaging to national economies and enterprise financial positions.

Among the categories and types of emissions that have been, or are being, addressed on a domestic and international basis, are nitrogen oxides (NO_{X}), sulfur oxide (SO₂), greenhouse gases (GHGs), mercury (Hg), Montreal gases, and for water, total maximum daily loads (TMDLs), among others. The NOₓ and SO₂ regulations and associated trading markets are very well developed in the United States and other select nations. Conversely, the Hg and TMDL markets appear to be on the verge of blossoming in the coming decade. In the middle ground between these two groups lies what may become the most significant of the emissions categories and types—that of GHGs.

Regardless of the emissions category or type, the regulatory or voluntary mechanisms and their interrelationship with corresponding emissions trading markets add complexity to the decision-making processes that entities or facilities must utilize in order to ascertain the optimal, or most appropriate strategies, for emissions cataloging, management, planning, and investment. In order to illustrate the complexities that can occur in these instances and that have given rise to the present invention, trends in emissions reduction and trading activities, and their impact, upon entities and facilities may provide a suitable case study regarding these emissions categories and types.

From the United Nations to the Nassau County (New York) Legislature, public bodies have set efforts in motion to reduce emissions, ranging from NO_{X} to SO₂ to GHGs. The disparate efforts regarding these emissions, some complementary, others contradictory, leave entities with critical choices regarding investments to meet new regulatory and voluntary targets. As regulatory regimes are put into place, they are often accompanied by emissions trading programs, which add further complexities to emissions management. Adding to the complications of managing the investments and trades in this arena is the fact that entities with facilities or interests in multiple locations may be subject to different structures in different locales which are rapidly emerging.

In addition to the regulatory and voluntary mechanisms put in place by governments, many entities are initiating action in order to meet the demands of their insurance carriers or financial institutions regarding emissions management standards, or to create an aura of sustainability in the minds of stakeholders.

These goals, both regulatory and voluntary, point to a need for entities to address emissions management issues today. Clearly, emissions management in this tapestry of regulations and voluntary mechanisms is less than straightforward in application. Thus, the emerging arena of emissions management poses great strategic challenges to many enterprises, including, but not limited to, energy companies, public entities, industrial businesses, and emissions trading firms. Inherent in designing entity emissions management approaches are complex interplays between regulatory requirements, specific project investments, trading of emission allowances, reductions or credits, and risk management. Presently, most enterprises are using a combination of ill-equipped spreadsheets and often-lost documents to perform their internal tracking of emissions management activities. Nearly all enterprises would agree that their current methods involve sub-optimal tools and information to meet the demands of this emerging market. In order to effectively and efficiently manage in this environment, entities will need robust computing tools to manage information, make knowledgeable decisions, and undertake appropriate investments regarding emissions management.

Clearly, decisions regarding data collection methods are extremely difficult enough given the shear volume of information that must be gathered, analyzed, and compared. However, the formulation of strategies to optimize an emissions management portfolio will likely prove to be especially arduous. When the gamut of project specific investment or trading opportunities are analyzed with reference to the various regulatory and emissions trading mechanisms being implemented around the world, clear lines of connectivity may be difficult to discern. For small, local companies, multinational entities and public entities, alike, these regulatory structures, investment possibilities, and trading options raise serious questions. These questions presently can be answered only through time-consuming data management and running countless “what-if” scenarios to ensure appropriate site-specific strategies, followed by the synthesizing of these approaches into an effective, coherent strategy sensitive to the demands of each regulatory regime. This process requires significant financial investments by entities in numerous knowledgeable analysts and/or computing applications that are insufficiently equipped with the tools to perform the multi-dimensional task at hand. At present, no singular method, or system or computing product exists to aptly display for the best options for effective and economically feasible emissions management. Thus, presently strategic planning costs significantly increase assessment costs.

Cost-effective, economically efficient implementation of emissions management approaches, from energy conservation to emission allowances trading and from emissions reduction trading to investment in offset projects, cannot be easily undertaken without an advanced means to track, validate, compare, and analyze the myriad of factors affecting the design and execution of an entity's emissions management strategies. As regulations, voluntary measures, emerging energy technologies, and trading mechanisms appear with increased speed, the time for the development of an advanced method, system, and computer software product focused on emissions cataloging, management, and planning has arrived.

The timeliness for the development of method, a system, and computer software product for emissions cataloging, management, and planning is matched by the ripeness of the development of methods, systems, and computer software products for the cataloging, management, analyzes and comparisons of other emissions categories and types.

### SUMMARY OF THE INVENTION

To provide for emissions cataloging, management, and planning, disclosed herein is the invention which is a method, system, and computer program product that provides the functions for emissions cataloging, viewing, management, strategic planning, and reporting. The invention further provides an integrated, modular mechanism with dynamic, ownership-based data promulgation for making strategic performance assessments and investment decisions. The invention uses a plurality of databases or datastores for storing, tracking, analyzing and comparing emissions information, emissions management activity information, market information, regulatory and voluntary compliance information, risk management information, as well as financial, legal, and production information, at an entity, facility, process, or other level. The invention further includes a user interactive feature that provides a means for the user of the invention to enter data and receive data analysis and compare output displays from a central client server.

An advantage of the present invention is that it is possesses analytical capabilities, supported by sophisticated databases or datastores of entity emissions information, emissions management activity information, and financial and production information which allows the present invention to display to users of the invention the emissions and net emissions and further emissions positions for entities, facilities, processes, activities, within a multi-layered hierarchy.

Another advantage of the present invention is that it provides, as a result of its database and datastore structure, a means that displays to the user dynamic, ownership-based promulgation of emissions and emissions-related information in a manner that mirrors the legal structure(s) and ownership structure(s) of the enterprise, in terms of subsidiaries, joint ventures, facilities, processes and other entities of the enterprise.

Another advantage of the present invention is that it provides a datastore of information on emissions management regulatory and voluntary compliance goals, targets, or other measures, and allows for user inputs of additional compliance goals, targets, or other measures, which displays to users of the invention information which determines whether an entity or facility will meet such compliance goals, targets, or other measures, within a given or varying time period.

Another advantage of the present invention is that it provides a datastore of emissions market information for emissions-based commodities, futures, derivatives and other instruments, which allows the present invention to assist users of the invention to examine emissions management portfolios, structure emissions management portfolios, examine merits of an emissions management activity, or activities, and structure an emissions management activity, or activities.

Another advantage of the present invention is that it provides, as a result of its archiving of the information and data input into the database, a means for validation, verification, analysis and comparisons which are displayed to the user and third parties, information which ensures that entity, facility, process, or other level emission activities will be accepted by governments and markets.

Another advantage of the present invention is that it provides a means for the display to the user information which assesses the type, level, and degree of risk associated with the emission management portfolio, activity, or activities.

Further features and advantages of the invention as well as the structure, operations and functions of various embodiments of the present invention are described in detail below with reference to the accompanying drawings.

### DESCRIPTION OF THE DRAWINGS/FIGURES

The features and advantages of the present invention will become more apparent from the detailed description, set forth below, when taken in conjunction with the drawings in which like reference numbers indicate identical or functionally similar elements. Additionally, the left-most digit of a reference number identifies the drawing in which the reference number first appears.

FIG. 1 is a block diagram illustrating the system architecture of an embodiment of the present invention, showing network connectivity among the various components;

FIG. 2 is a block diagram illustrating the software architecture of an embodiment of the present invention, showing communication among the various components of an embodiment of the system of FIG. 1;

FIG. 3 is a block diagram illustrating the various subsystems and data processing systems and the interaction between the navigation control system that may be executed by an embodiment of the system of FIG. 1;

FIG. 4 is a block diagram illustrating the subsystems, subcontrol systems, and data processing systems, and the interaction between the hierarchy control system that may be executed by an embodiment of the system of FIG. 1;

FIG. 5 is a block diagram illustrating the subsystems and data processing systems, and the interaction between the global location control system that may be executed by an embodiment of the system of FIG. 1;

FIG. 6 is a block diagram illustrating the administration data processing system that may be executed by an embodiment of the system of FIG. 1;

FIG. 7 is a block diagram illustrating the non-emissions entity data processing system that may be executed by an embodiment of the system of FIG. 1;

FIG. 8 is a block diagram illustrating the emissions inventory data processing system that may be executed by an embodiment of the system of FIG. 1;

FIG. 9 is a block diagram illustrating a system for entry and analysis of information on emissions management activities, including, but not limited to, emissions reduction, offset, and trading activities, that may be executed by an embodiment of the system of FIG. 1;

FIG. 10 is a block diagram illustrating a system for entry of regulatory and voluntary compliance goal information that may be executed by an embodiment of the system of FIG. 1;

FIG. 11 is a block diagram illustrating a system for entry of emissions market information that may be executed by an embodiment of the system of FIG. 1;

FIG. 12 is a block diagram illustrating a system for generating various types of graphs that correspond with the datasets that are generated by the reports generator data processing system that are executed by an embodiment of the system of FIG. 1;

FIG. 13 is a block diagram illustrating the plurality of query operations to examine emissions inventory assessments that are executed by an embodiment of the system of FIG. 1;

FIG. 14 is a block diagram illustrating the plurality of query operations to examine net emissions portfolio/activity positions that are executed by an embodiment of the system of FIG. 1;

FIG. 15 is a block diagram illustrating the plurality of query operations to examine net emissions positions against normalized metrics that are executed by an embodiment of the system of FIG. 1;

FIG. 16 is a block diagram illustrating the plurality of query operations to examine net emissions positions against regulatory and voluntary compliance goal information that are executed by an embodiment of the system of FIG. 1;

FIG. 17 is a block diagram illustrating the plurality of query operations to examine emissions management portfolio/activity financial assessments that are executed by an embodiment of the system of FIG. 1;

FIG. 18 is a block diagram illustrating the plurality of query operations to examine emissions management portfolio/activity within the context of the marketplace that are executed by an embodiment of the system of FIG. 1;

FIG. 19 is a block diagram illustrating the plurality of query operations to examine net emissions financial assessments against regulatory and voluntary compliance information within the context of the market place that are executed by an embodiment of the system of FIG. 1;

FIG. 20 is a block diagram illustrating the plurality of query operations to examine emissions management portfolio/activity risk analysis that are executed by an embodiment of the system of FIG. 1; and

FIG. 21 is a block diagram of an exemplary computer system useful for implementing the present invention.

### DETAILED DESCRIPTION OF THE INVENTION

The following discussion describes in detail one or more embodiments of the invention. This discussion should not be construed, however, as limiting the invention to those particular embodiments, and practitioners skilled in the art will recognize numerous other embodiments as well. The complete scope of the invention is defined in the claims appended hereto.

System Architecture

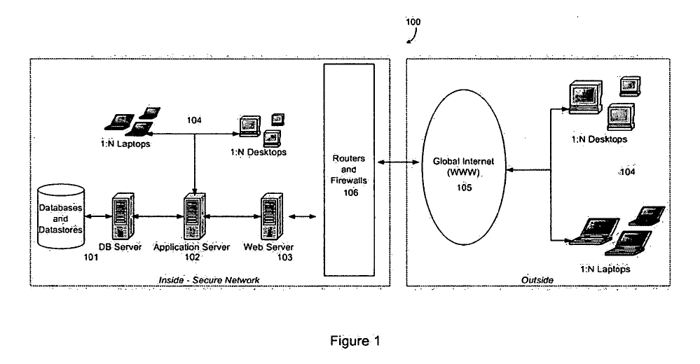

Referring to FIG. 1, a block diagram illustrating the physical architecture of the cataloging, management, and planning system 100, according to an embodiment of the present invention, showing network connectivity among the various components, is shown. It should be understood that the particular system 100 shown in FIG. 1 is for illustrative purposes only and does not limit the invention. Other implementations for performing the functions described herein will be apparent to persons skilled in the relevant art(s) based on the teaching contained herein, and the invention is directed to such other implementations.

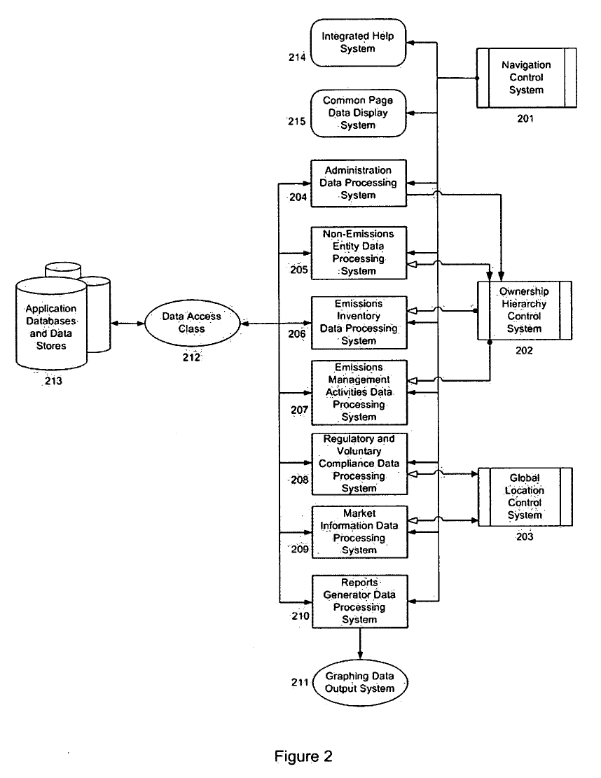

The system 100, as shown in FIG. 1 and FIG. 2, is divided into two regions—“inside” and “outside.” The components appearing in the inside region refer to those components that the system provides for utilization of the present invention. As will be apparent to one skilled in the relevant art(s), all of components “inside” of the cataloging, management, and planning system 100 are connected and communicate via a communication medium such as a wide or local area network (WAN or LAN) 101 running a secure communications protocol (e.g. secure sockets layer (SSL)).

In contrast, the components appearing in the outside region refer to the infrastructure that the users of the system 100 refer to the infrastructure that the users of the system 100 would obtain or already have in place in order to utilize the system 100. In this embodiment, the inside and outside components are connected through the global Internet 105, which includes the World Wide Web 106.

The system 100 includes an application server 102 that serves as the “back end” (i.e. central processing system) of the present invention. Connected to application server 102 is a database 103 with components, as described in FIG. 2. The application server 102 is also connected to a Web server 103. As is well-known in the relevant art(s), a Web server is a server process running at a Web site which sends out web pages in response to Hypertext Transfer Protocol (HTTP) requests from remote browsers. The Web server 103 serves as the “front end” of the present invention. That is, the Web server 103 provides the graphical user interface (GUI) to users of the cataloging, management, and planning system 100 in the form of Web pages. Such users may access the Web server 103 for their entity via a plurality of workstations 104, both internal to the entity and external which must be accessed for use via the global Internet 105.

To further illustrate the “inside” architecture of the system, referring to FIG. 2, the block diagram illustrates the databases and datastores 213, an embodiment of the cataloging, management, and planning system 100 according to an embodiment of the present invention, showing communication among these various software-based components. Within these databases and datastores, exist multiple data processing systems, including but not limited to an Administration Data Processing System 204, a Non-Emissions Entity Data Processing System 205, an Emissions Inventory Data Processing System 206, an Emissions Management Activities Data Processing System 207, a Regulatory And Voluntary Compliance Data Processing System 208, a Market Information Data Processing System 209, and a Reports Generator Data Processing System 210. All access to data within the databases and datastores will be via the Data Access Class 212, which regulates reads, writes, and updates to the data based on user privileges and security settings.

As a result, the present invention provides an online, emissions cataloging, management, and planning system 100. The invention is a method, system, and computer program product that provides for emissions cataloging, analyses, comparisons, management, strategic planning, reporting and display viewing. The invention further provides an integrated, modular mechanism with dynamic, ownership-based data promulgation within an enterprise for making strategic performance assessments and investment decisions. The invention uses a plurality of data processing systems including, but not limited to, an Administration Data Processing System 204, a Non-Emissions Entity Data Processing System 205, an Emissions Inventory Data Processing System 206, an Emissions Management Activities Data Processing System 207, a Regulatory And Voluntary Compliance Data Processing System 208, a Market Information Data Processing System 209, as well as a Reports Generator Data Processing System 210, for storing, tracking, analyzing and comparing information at an entity, facility, process, and/or other level.

General System Operation

Referring to FIG. 2, this block diagram illustrates the various data processing systems and control systems, and the interaction between the application databases and datastores within an embodiment of the system 100 of FIG. 1. These data processing systems and control systems include, but are not limited to, a Navigation Control System 201, an Ownership Hierarchy Control System 202, a Global Location Control System 203, an Administration Data Processing System 204, a Non-Emissions Entity Data Processing System 205, an Emissions Inventory Data Processing System 206, an Emissions Management Data Processing System 207, a Regulatory And Voluntary Compliance Data Processing System 208, a Market Information Data Processing System 209, a Reports Generator Data Processing System 210, a Graphing Output System 211, an Integrated Help System 214, and a Common Page Data Display System 215.

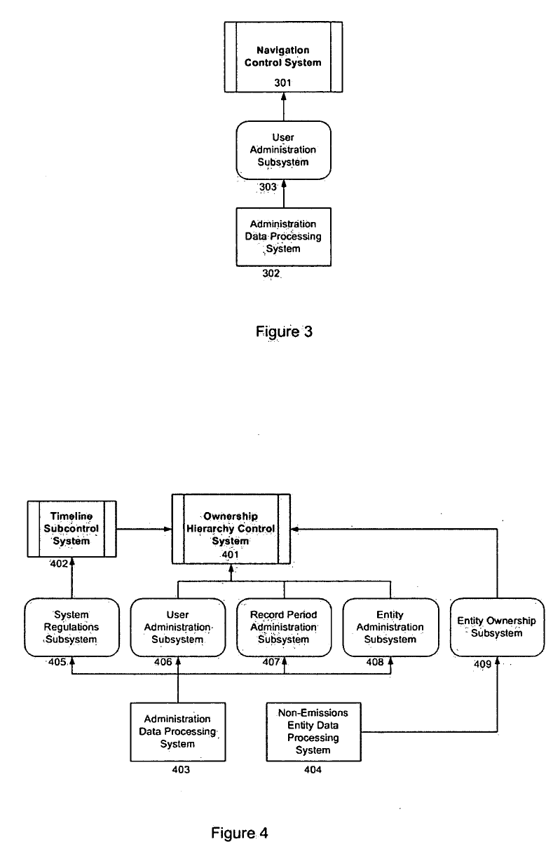

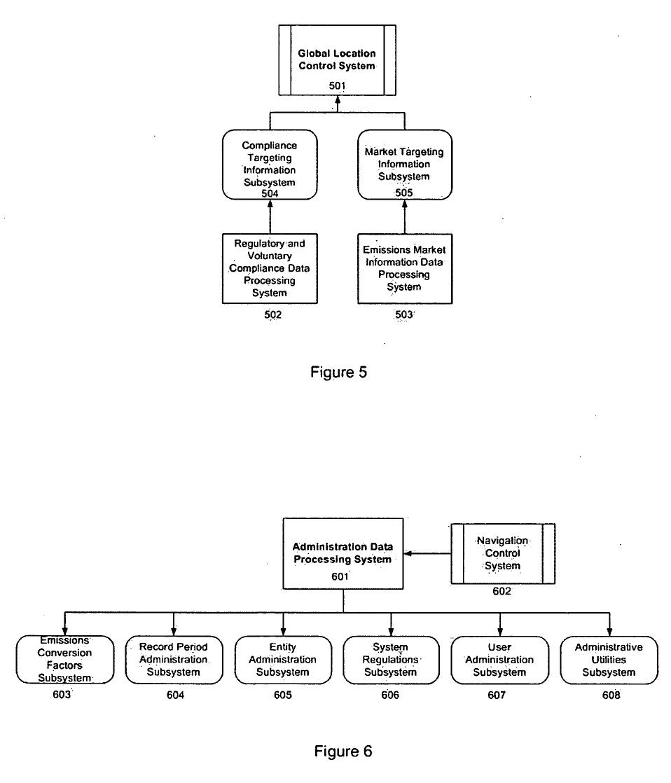

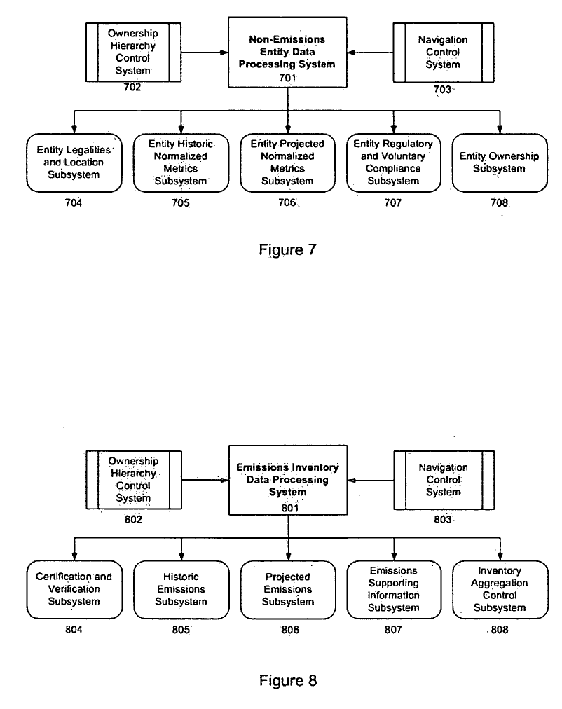

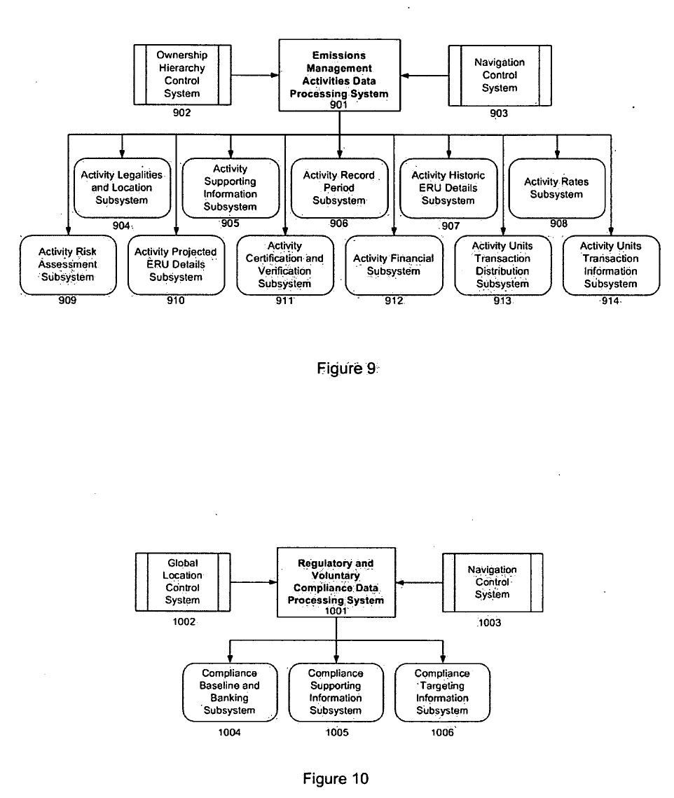

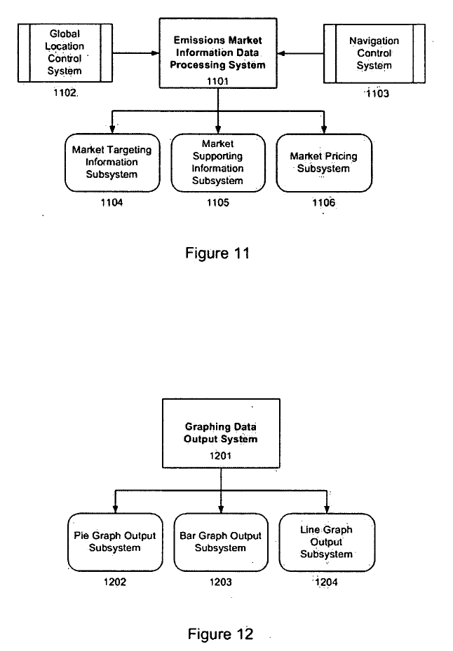

Collectively, the application databases and datastores 213 via the data access class 212, in conjunction with the data processing systems and control systems, permit a user to enter, delete, update or query data and information relevant to emissions management cataloging, tracking, and planning. More details on the structure of the delineated data processing systems are presented in FIG. 3 (Navigation Control System 201), FIG. 4 (Ownership Hierarchy Control System 202), FIG. 5 (Global Location System 203), FIG. 6 (Administration Data Processing System 204), FIG. 7 (Non-Emissions Entity Data Processing System 205), FIG. 8 (Emissions Inventory Data Processing System 206), FIG. 9 (Emissions Management Activities Data Processing System 207), FIG. 10 (Regulatory And Voluntary Compliance Data Processing System 208), FIG. 11 (Emissions Market Information Data Processing System 209), and FIG. 12 (Graphing Data Output System 211).

Referring to FIG. 3, this block diagram illustrates the various subsystems and data processing systems and the interaction between the Navigation Control System 301 within an embodiment of the system 100 of FIG. 1. This Navigation Control System 301 controls all navigation to the different data processing systems of the system 100. The Navigation Control System 301 includes, but is not limited to, the User Administration Subsystem 303 (from the administration data processing system 302) that provides the user access to different data processing systems within system 100.

The Navigation Control System 301 functions as the main control system that grants and limits user access to the different modular areas of the system 100. The navigation control system 301 limits all paths between the user of the system 100 and the different data processing systems. User privileges from the User Administration Subsystem 303 will be communicated to the navigation control system 301 which will maintain a customized set of navigational rules depending on the user.

Referring to FIG. 4, this block diagram illustrates the various subsystems, subcontrol systems, and data processing systems, and the interaction between the Hierarchy Control System 401 within an embodiment of the system 100 of FIG. 1. The Ownership Hierarchy Control System 401 includes, but is not limited to, the Timeline Subcontrol System 402, the System Regulations Subsystem 405 (via the Administration Data Processing System 403), the User Administration Subsystem 406 (via the Administration Data Processing System 403), the Record Period Administration Subsystem 407 (via the Administration Data Processing System 403), the Entity Administration Subsystem 408 (via the Administration Data Processing System 403), and the Entity Ownership Subsystem 409 (via the Non-Emissions Data Processing System 404). Collectively, they provide a set of ownership rules, time period rules, and enterprise hierarchy rules that interact with the different data processing systems to provide the correct relationships between entities and their subordinate entities within system 100.

The Hierarchy Control System 401 serves as the main set of rules and an interface that determines the unique relationships and rule sets for all of the entities within an enterprise. The Hierarchy Control System 401 works in conjunction with the different modular systems to provide the user with an accurate view of the enterprise as a whole, including ownership percentages, ownership rules, and enterprise hierarchies, for individual time periods such as annual, quarterly, and monthly. The Hierarchy Control System 401 provides a graphical interface, in the form of a collapsible tree structure, which shows the proper relationships between entities within system 100.

Referring to FIG. 5, this block diagram illustrates the various subsystems and data processing systems, and the interaction between the Global Location Control System 501 within an embodiment of the system 100 of FIG. 1. The Global Location Control System 501 includes, but is not limited to, the Compliance Targeting Information Subsystem (via the Regulatory and Voluntary Compliance Data Processing System 502) and the Market Targeting Information Subsystem 505 (via the Emissions Market Information Data Processing System). Collectively, they provide information that interacts with the Regulatory and Voluntary Compliance Data Processing System 502 and the Emissions Market Information Data Processing System 503 to establish a set of rules for geographic locations referred to within system 100.

The Global Control System 501 serves as the main set of rules and an interface that govern the relationships between the many global locations of the compliance and market data within system 100. The Global Control System 501 will prevent data anomalies by establishing a system-wide set of geographic rules to maintain data of different jurisdictions having similar location areas. Jurisdiction types for the data include classifications such as international, multinational, national, and state and local. The Global Control System 501 establishes the difference in, for example, the same state or nation within different jurisdictions. The Global Control System 501 will allow a user to dynamically add, delete, and update locations within system 100 while still maintaining data integrity. The Global Control System 501 provides a graphical interface, in the form of a collapsible tree structure, which shows the proper relationships between jurisdictional locations and compliance and market data.

Referring to FIG. 6, this block diagram illustrates the methods and systems that work in conjunction to comprise the Administration Data Processing System 601 that may be executed by the embodiment of the system 100. The Administration Data Processing System 601 houses the Emissions Conversion Factors Subsystem 603, the Record Period Administration Subsystem 604, the Entity Administration Subsystem 605, the System Regulations Subsystem 606, the User Administration Subsystem 607, and the Administrative Utilities Subsystem 608. Working in direct conjunction with the Administration Data Processing System 601 is the Navigation Control System 602.

The Administration Data Processing System 601 controls the overall access rights, controls the settings, controls administrative utilities, as well as ascertaining whether the system 100 has been optimized. The various subsystems perform the assignment of conversion factors, record time period settings, entity level settings, and user administration settings. In addition, the Administration Data Processing System 601 houses the administrative utilities that include, but is not limited to, the ability to confirm that data for other data processing systems have been completed and linked to perform dynamic ownership-based promulgation of data contained within said data processing systems.

The Administration Data Processing System 601 acts as the central management hub for users of the system 100. The User Administration Subsystem 607 stores and controls all pertinent information that pertains to a specific user. The User Administration Subsystem 607 handles and manages the users and user privileges and has the ability to set, limit, or extend access rights to the system 100 at different types of levels of control and utilization including, but not limited to, data processing system access, and enterprise entity navigation access rights. Further, the Administration Data Processing System 601 serves as a central management hub for the entities, subsidiaries, joint ventures, facilities, processes, and the like that may be the subject of the system 100 due to their emissions, emissions reductions, emissions offset, or otherwise as it handles creation, deletion, and duplication of entities, subsidiaries, joint ventures, facilities, processes, and the like via the Entity Administration Subsystem 605. In addition, the Entity Administration Subsystem 605 handles the linking of the ownership of a said entity, subsidiary, joint venture, facility, process, and the like, other entities, subsidiaries, joint ventures, facilities, processes, and the like owned by a said entity, subsidiary, joint venture, facility, process, and the like, and percentage of ownership data.

The Emissions Conversion Factors Subsystem 603 stores and controls all conversion factor information that pertains to the system 100. The Emission Conversion Factors Subsystem 603 controls the system-wide conversion factors that will be applicable to the system 100. The assigned conversion factors for individual emissions are applied when combining or displaying emissions as a common equivalent to one another. The Record Period Administration Subsystem 604 maintains and controls all record time period information that pertains to the system 100. The entering of information on a measurement basis of annual, quarterly, monthly, and other time periods, and the development of meaningful, time-based analysis as a result of the regularity measurement settings for all entity, subsidiary, joint venture, facility, process, and other levels are performed by the Record Period Administration Subsystem 604.

The System Regulations Subsystem 606 stores and controls all system-wide regulations that pertain to the system 100. The System Regulations Subsystem 606 includes but is not limited to information on rules of ownership of entities, emissions, emissions investments, and standards for measurement. The Administration Utilities Subsystem 608 provides a mechanism that includes, but is not limited to, the ability to confirm that data for other data processing systems have been completed and linked to perform dynamic ownership-based promulgation of data contained within said data processing systems. Examples of these utilities include, but are not limited to, examination of emissions and other non-emissions information and data.

Referring to FIG. 7, this block diagram illustrates the methods and systems that work in conjunction to comprise the Non-Emissions Entity Data Processing Systems 701 that may be executed by an embodiment of the system 100. The Non-Emissions Data Processing System 701 houses the Entity Legalities and Location Subsystem 704, the Entity Historic Normalized Metrics Subsystem 705, the Entity Projected Normalized Metrics Subsystem 706, the Entity Regulatory and Voluntary Compliance Subsystem, and the Entity Ownership Subsystem 708. In direct conjunction with the Non-Emissions Entity Data Processing System 701 are two control systems: the Ownership Hierarchy Control System 702 and the Navigation Control System 703.

The Entity Legalities and Location Subsystem 704 stores and correlates all legal and location information that pertains to a specific entity. The Entity Legalities and Location Subsystem 704 maintains information about the enterprise structure from principle entity to subsidiary entities, and from facilities to emissions generating processes, among other entity types, established in the Administration Data Processing System 601 (of FIG. 6). In addition, the Entity Legalities and Location Subsystem 704 processes information regarding the basic characteristics of the entity, subsidiary, joint venture, facility, process, including but not limited to, sector of operation and location information.

The Entity Historic Normalized Metrics Subsystem 705 stores and correlates normalized metrics for an entity, subsidiary, joint venture, facility, process and the like. Normalized metrics are a transformation of a numerical value into a separate system of standards or conceptual meaning. Normalized metrics include, but are not limited to, such metrics as gross revenue, net revenue, and product yields. Normalized metrics are identified by the Entity Administration Subsystem (of FIG. 6) in the Administration Data Processing System 601 (of FIG. 6) for individual entities within the enterprise and are maintained by the Entity Historic Normalized Metrics Subsystem 705. The normalized metrics are maintained for the time periods that correspond with the time period settings in the Record Period Administration Subsystem 604 (of FIG. 6). Projected normalized metric scenarios for any entity, subsidiary, joint venture, facility, process, and the like are stored and correlated to a specific entity via the Entity Projected Normalized Metrics Subsystem 706. The Entity Projected Normalized Metrics Subsystem 706 manages different projected normalized metric scenarios associated with a given entity in order to reflect potential ‘what if’ scenarios in addition to ‘business as usual’ scenarios. These different scenarios are created and maintained separately and function to analyze potential projected positions for a given scenario.

The Entity Regulatory and Voluntary Compliance Subsystem 707 stores and correlates compliance goals that pertain to a specific entity. The Entity Regulatory and Voluntary Compliance Subsystem 707 assigns and maintains the enterprise wide environmental program goals (communicated via the System Regulations Subsystem 606 of FIG. 6) as well as individual enterprise entity environmental program goals.

The Entity Ownership Subsystem 708 stores and correlates the ownership relations of an entity, subsidiary, joint venture, facility, process, and other such activities with the enterprise structure for any given time period that corresponds with the record time period settings in the Record Period Administration Subsystem 604 (of FIG. 6). These relationships include but are not limited to other entities, subsidiaries, joint ventures, facilities, processes, and the like owned by the said entity; the percentage of ownership data between entities within the enterprise structure, and information regarding the accounting rules for ownership of emissions inventory and emissions investments for any entity, subsidiary, joint venture, facility, process, and the like.

Referring to FIG. 8, this block diagram illustrates the methods and systems that work in conjunction to comprise the Emissions Inventory Data Processing System 801 that may be executed by an embodiment of the system 100. The Emissions Inventory Data Processing System 801 will house the Certification and Verification Subsystem 804, the Historic Emissions Subsystem 805, the Projected Emissions Subsystem 806, the Emission Information Subsystem 807, and the Inventory Aggregation Control Subsystem 808. Working in direct conjunction with the Emissions Inventory Data Processing System 801 will be two control systems: the Ownership Hierarchy Control System 802 and the Navigation Control System 803.

The Certification and Verification Subsystem 804 stores and correlates all certification and verification activities that pertain to a specific entity's emissions inventory for a given time period. Certifications and verifications on emissions inventories are a form of assurance that the emissions produced or reduced by said entity are accurate. The Certification and Verification Subsystem 804 handles the methodology, verifying organization and information, and other relevant information pertaining to an entity's inventory certification, validation, or verification.

The Historic Emissions Subsystem 805 stores and correlates historic emissions for any entity, subsidiary, joint venture, facility, process, and other such activities. Emissions are identified on a basis of a particular emission and emissions type including, but not limited to, direct, indirect, and/or total emissions for periods that correspond with the specified record time period settings in the Record Period Administration Subsystem 604 (of FIG. 6). Future emissions for any entity, subsidiary, joint venture, facility, process, and other such activities are stored and correlated to a specific entity's emissions inventory via the Projected Emissions Subsystem 806. Emissions are identified on a basis of a particular emission and emissions type including but not limited to direct, indirect, and/or total emissions on a user-defined time period or by the last defined time period of the current year. The Projected Emissions Subsystem 806 manages different projected emissions scenarios associated with a given entity in order to reflect potential ‘what if’ scenarios in addition to ‘business as usual’ scenarios.

The Emissions Supporting Information Subsystem 807 will store and correlate all supporting details information that pertains to a specific entity's emissions inventory. The Emissions Supporting Information Subsystem 807 maintains the emissions sources, calculation methodology, and other relevant information that will provide more insight to an entity's emissions inventory.

The Inventory Aggregation Control Subsystem 808 provides the correct subordinate level locations within the enterprise structure to retrieve emissions inventory data for any specific time period and entity. As the data is retrieved, each individual record is filtered through the Entity Ownership Subsystem 708 (of FIG. 7) of the Non-Emission Entity Data Processing System 701 (of FIG. 7) where the inventory totals are transformed and revalued to reflect all ownership percentages and rule sets at each enterprise level for the respective individual time periods. Each entity's inventory data set is converted to a weighted equivalent in which different emissions can be measured in a common equivalency, via the Emission Conversion Factors Subsystem 602 (of FIG. 6) of the Administration Data Processing System 601 (of FIG. 6). The Inventory Aggregation Control Subsystem 808 is applied to historic and projected emission inventory totals. Referring to projected emissions, the Inventory Aggregation Control Subsystem 808 uses the enterprise structure of a user-defined time period or the last defined time period of the current year to perform future projections and aggregates all of the necessary inventory data for each given time period of individual projection scenario data sets. In order to support the dynamic, ownership-driven promulgation option provided for by the system, information is maintained regarding the completeness of the emissions information via the Inventory Aggregation Control Subsystem 808, including the historic emission inventories and projected emission inventories, as well as the potential for utilization of this information in said promulgation.

Referring to FIG. 9, this block diagram illustrates the methods and systems that work in conjunction to comprise the Emissions Management Activities Data Processing System 901 that may be executed by an embodiment of the system 100. The Emissions Management Activities Data Processing System 901 houses and correlates the Activity Legalities and Location Subsystem 904, the Activity Supporting Information Subsystem 905, the Activity Record Period Subsystem 906, the Activity Historic Emissions Units Details Subsystem 907, the Activity Rates Subsystems 908, the Activity Risk Assessment Subsystem 909, the Activity Projected Emissions Units Details Subsystem 910, the Activity Certification and Verification Subsystem 911, the Activity Financial Subsystem 912, the Activity Units Transaction Distribution Subsystem 913, and the Activity Units Transaction Information Subsystem 914. Working in direct conjunction with the Emissions Management Activities Data Processing System 901 are the two control systems: the Ownership Hierarchy Control System 902 and the Navigation Control System 903.

The Emissions Management Activities Data Processing System 901 is a method for maintaining and correlating information and data on emissions management activities. The types of emissions management activities include, but are not limited to, allowances—units of a emissions under a governmental cap and trade system that grants an organization the right to emit the emissions; credits—units of emissions under a governmental baseline and credit system that grants an organization the right to emit the emissions; emissions reductions—units of emissions that are generated from an emissions reducing capital investment project that occurs in the absence of emissions standards; verified emissions reductions—in the absence of emissions standards, units of emissions that are created from an emissions reducing capital investment project and verified by a third party; call options—legal contracts allowing a buyer the right to purchase a quantity of units of emissions at a fixed price on or prior to an expiration date; put options—legal contracts allowing a buyer the right to purchase and sell a quantity of units of emissions at a fixed price on or prior to an expiration date; swaps—legal contracts representing a like-kind exchange of units of emissions; collars—legal contracts that provide future emissions reduction units, establish a minimum future selling price by the seller, and a maximum future purchasing price by the buyer; and forward streams—legal contracts that provide future emissions reduction units.

The Emissions Management Activities Data Processing System 901 maintains and correlates information pertaining to emissions management activities. Each subsystem and detailed area manages and maintains information which is necessary to fully characterize the nature of the emissions management activity record in the Emissions Management Activities Data Processing System 901. Collectively, the information maintained by the Emissions Management Activities Data Processing System 901 comprises a single emissions management activity record and in aggregate comprises a potential emissions management activity portfolio.

The Activity Legalities and Location Subsystem 904 will store and correlate all legal and location information that pertains to a specific investment activity. The Activity Legalities and Location Subsystem 904 maintains and correlates the information about the investment activity legal structure, ownership percentages, emission reduction focuses, and also information regarding the basic characteristics of the investment activity. Information maintained by the Activity Legalities And Location Subsystem 904 include, but is not limited to, data related to the name of the emissions management activity, the active time period for the emissions management activity, the location of the emissions management activity, the owning enterprise entity of the emissions management activity via the Ownership Hierarchy Control System 902, percentage of ownership of the owning enterprise entity, the manner in which said emissions management activity was obtained or initiated, the status of the emissions management activity, the type of emissions management activity, the sector and process that derive the emissions management activity, the emissions focus for the emissions management activity, as well as additional information on the emissions management activity via the Activity Supporting Information Subsystem 905. The Activity Supporting Information Subsystem 905 maintains emissions management supporting information for said activities including, but not limited to, sources of emissions, emissions calculation methodology, and other background information. In aggregate, this information may also be used by third parties to certify, validate and/or verify emissions management activity or activities via the Activity Certification and Verification Subsystem 911.

The Activity Record Period Subsystem 906 manages and maintains the working time periods for each year within a given activity. All subsystems within the Emissions Management Activities Data Processing System 901 are linked to the Activity Record Period Subsystem 906 to maintain a correlation between individual data sets. The Activity Record Period Subsystem 906 maintains data integrity between data sets and manages the data for individual years of a given activity including the ability to utilize different time periods for those individual years including annual, quarterly, or monthly data sets. In addition, the Activity Record Period Subsystem 906 aggregates and separates data sets for each subsystem, when a time period for a given year of a given activity is changed, while maintaining data integrity.

The emission reduction units for an enterprise are determined via the Activity Historic ERU Details Subsystem 907 and the Activity Projected ERU Details Subsystem 910 for any given time period predicated by the Activity Record Period Subsystem 906 and for any given emission and emissions type including, but not limited to, direct, indirect, and/or total emissions. The Projected Emissions Subsystem 806 analyzes different projected emissions reduction scenarios associated with a given activity in order to reflect potential ‘what if’ scenarios in addition to ‘business as usual scenarios’. Each emission and emission type of the said activity is converted to a weighted equivalent via the Emission Conversion Factors Subsystem 603 (of FIG. 6) of the Administration Data Processing System 601 (of FIG. 6) and aggregated to a total emissions value for a given time period or combinations of time periods thereof. These total values are correlated with the Activity Certification and Verification Subsystem 911 to track and manage the verification and certification information for the given time periods of the said activity specified by the Activity Record Period Subsystem 906.

The Activity Units Distribution Subsystem 913 maintains and correlates emission reduction unit transactions within a given activity. Any emissions reduction units that have been or are projected to be transacted are maintained and correlated with the Activity Historic ERU Details Subsystem 907, the Activity Projected ERU Details Subsystem 910, and the Activity Financial Subsystem 912 to diagnose the correct placement and adjustments of activity information including, but not limited to, historic and projected emissions reduction unit inventories and financial revenues due to any fixed prices placed on the transacted emissions reduction units. The Activity Units Transaction Information Subsystem 914 will directly interact with the Activity Units Distribution Subsystem 913 to maintain pertinent information on individual transactions including but not limited to, legality and location information of other involved parties, pricing and quantity information, and market information.

The Activity Rates Subsystem 908 maintains and manages financial rate data for a given activity. These financial rates include, but are not limited to, discount rates, user-defined risk rates, internal rate of return, upper and lower bounds, and time value of money rates.

The Activity Financial Subsystem 912 maintains and correlates financial data for a given activity for the time periods defined in the Activity Record Period Subsystem 906 for the said activity. It stores, analyzes and compares data sets for projected emissions reduction costs, projected non-emissions reduction costs, historical emissions reduction costs, and historical non-emissions reduction costs including, but not limited to, premiums, development costs, taxes, loss of revenue costs, risk management costs, capitol equipment costs, installation costs, maintenance costs, debt, labor costs, and user defined costs. In addition, the Activity Financial Subsystem 912 generates fixed price costs associated with emissions reduction units maintained within the Activity Historic ERU Details Subsystem 907 and the Activity Projected ERU Details Subsystem 910. The Activity Financial Subsystem 912 stores and compares data sets for projected emissions reduction revenues, projected non-emissions reduction revenues, historical emissions reduction revenues, and historical non-emissions reduction revenues including, but not limited to, premiums, tax credits, incentives, salvage values, loans, and user defined revenues. In addition the Activity Financial Subsystem 912 generates fixed price revenues associated with emissions reduction units maintained within the Activity Units Distribution Subsystem 913. The Activity Financial Subsystem 912 correlates and aggregates the different cost and revenue datasets for the individual time periods defined in the Activity Record Period Subsystem 906 of the said activity and provides a visual output for activity whole cost and revenue values as well as user defined time period aggregations. The Activity Financial Subsystem 912 performs the necessary analysis of the aforementioned aggregated cost and revenue values, utilizing the defined rates in the Activity Rates Subsystem 908, and provides a visual output for discounted, risk adjusted, and time value of money adjusted cost and revenue values.

Activity Financial Subsystem 912 performs a series of economical analysis techniques and iterations, data aggregations, comparisons and correlates with the Activity Units Distribution Subsystem 913 and the Activity Rates Subsystem 908, to provide a visual output of financial merits of worth for the activity, including, but not limited to, internal rates of return, benefit-cost ratios, payback periods, net present values, and average annual costs.

Further, the Activity Risk Assessment Subsystem 909 maintains and manages activity risk data for a given emissions management activity record. This risk information includes informational data, including probabilities and impact values on financial and emissions reductions unit risks. The risks include, but are not limited to, market, currency, financial, political, regulatory, counterparty, and user defined risks are diagnosed and formulated into Financial Risk Rates and Financial Values at Risk for a given activity. The emissions reduction unit risks include, but are not limited to, performance, technology, political, regulatory, counterparty, and user defined risks, are diagnosed and formulated into Emissions Reductions Risk Rates and Emissions Volumes Values at Risk for a given activity.

Referring to FIG. 10, this block diagram illustrates the methods and systems that function in conjunction to comprise the Regulatory and Voluntary Compliance Data Processing System 1001 that may be executed by an embodiment of the system 100. The Regulatory and Voluntary Data Processing System 1001 houses the Compliance Baselining and Banking Subsystem 1004, the Compliance Supporting Information Subsystem 1005, and the Compliance Targeting Information Subsystem 1006. Functioning in direct conjunction with the Regulatory and Voluntary Compliance Data Processing System are two control systems: the Global Location Control System 1002 and the Navigation Control System 1003. As many emissions management regulations and voluntary compliance mechanisms are still emerging, the Regulatory and Voluntary Compliance Data Processing System 1001 performs not only generation of scenarios based on present regulatory schemes and voluntary compliance mechanisms, but hypothetical structures as well. Within this Regulatory and Voluntary Compliance Data Processing System 1001, information is maintained, that is related to the various compliance mechanisms, which will hereinafter be referred to as “environmental program goal(s),” but which may also include protocols, directives, laws, contracts, agreements, and other compliance-enabling mechanisms.

The Compliance Baselining and Banking Subsystem 1004 stores and correlates all baselining and banking information data that pertains to a given environmental program goal. The Baselining and Banking Subsystem 100 correlates one or more base years for a given environmental program goal baseline, and displays the option for averages, minimums and maximums of the calculated baselines as well as options to normalize against metrics including, but not limited to, gross revenue, net revenue, and product yield metrics. In addition, the Baselining and Banking Subsystem 100 correlates and analyzes the allowable emissions reduction unit distributions for the environmental program goal specifying the years that emissions reduction units must be applied to the applicable years they were generated or the years the units can be ‘banked’ to be applied to the targeted year specified in the Compliance Targeting Information Subsystem 1006.

The Compliance Targeting Information Subsystem 1006 stores and analyzes all targeting information that pertains to a specific compliance goal. The Compliance Targeting Information Subsystem 1006 correlates targeted years and percent reductions for the targeted years of a given goal. In addition, the Compliance Targeting Information Subsystem 1006 displays the option to normalize target goals against metrics including, but not limited to, gross revenue, net revenue, and product yield metrics.

Referring to FIG. 11, this block diagram illustrates the methods and systems that function in conjunction to comprise the Emissions Market Information Data Processing System 1101 that may be executed by an embodiment of the system 100. The Emissions Market Information Data Processing System 1101 houses the Market Targeting Information Subsystem 1104, the Market Supporting Information Subsystem 1105, and the Market Pricing Subsystem 1106. Functioning in direct conjunction with the Emissions Market Information Data Processing System 1101 are two control systems: the Global Location Control System 1102 and the Navigation Control System 1103. As many emissions management and trading marketplaces, commodities, and derivatives are still emerging and maturing, this Emissions Market Information Data Processing System 1101 is able to process not only entry of information on present marketplaces, commodities, and derivatives, but is structured in a flexible manner to process emerging emissions marketplaces, commodities, and derivatives, as well. The Emissions Market Information Data Processing System 1101 serves as the most time-sensitive portion of the system 100 and the data contained within this module will drive many emissions management activity options derived by users.

The Market Targeting Information Subsystem 1104 stores and analyzes all market targeting information that pertains to a specific market price projection scenario. The Market Targeting Information Subsystem 1104 displays the pertinent time periods of the given market projections and the levels at which the projections are maintained including, but not limited to, monthly, quarterly, and annual projections. In addition the Market Targeting Information Subsystem 1104 has the ability to convert projections between said levels of time periods by expanding price projections of lesser detailed time periods into records or more detailed time periods or combining price projections from more detailed time periods into lesser detailed time periods.

The Market Supporting Information Subsystem 1105 stores and analyzes all market supporting information that pertains to a specific market price projection scenario. The Market Supporting Information Subsystem 1105 displays information on the trading platforms of the market projection which includes different markets, exchanges, and platforms, the currency type applicable to the market projection, the methodology of the market projections, and the type of market projection, including, but not limited to, units of emissions, verified units of emissions, call options per unit of emissions, collars per unit of emissions, credits per unit of emissions, forward streams per unit of emissions, put options per unit of emissions, and swaps per unit of emissions.

The Market Pricing Subsystem 1106 will store and analyze all market prices that pertains to a given market price projection scenario on a time period defined in the Market Targeting Information Subsystem 1104 including but not limited to monthly, quarterly, or annual basis. In addition, these prices are automatically updated with time-sensitive data feeds received by the system. The data storage techniques implemented by the Market Pricing Subsystem 1106 are relational to emissions and environmental activity datasets in order to display direct comparisons to other financial values employed by the system 100.

Referring to FIG. 12, this block diagram illustrates the method for generating various types of graphs that correspond with various datasets that are generated by the reports generator data processing system 1201 within the system 100. The Graphing Data Output System 1201, includes but is not limited to, the Pie Graph Output Subsystem 1202, the Bar Graph Output Subsystem 1203, and the Line Graph Output Subsystem 1204. Each output subsystem analyzes datasets produced by the Graphing Data Output System 1201 and generates a visual output allowing the user to graphically visualize the datasets generated by the Reports Generator Data Processing System 210 (of FIG. 2).

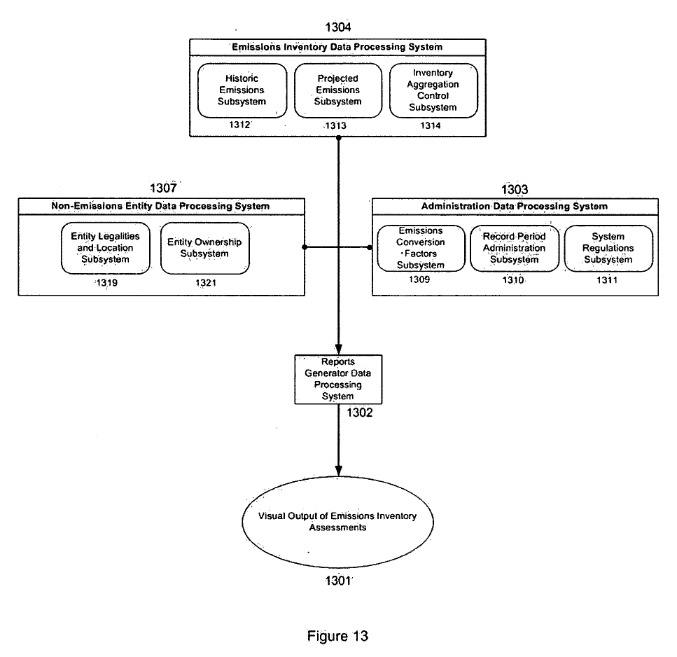

Referring to FIG. 13, this block diagram illustrates the methods and systems that take part in the plurality of query operations to analyze the emissions portfolio positions that may be executed by an embodiment of the system 100 for a given enterprise entity which consists of an entity, subsidiary, joint venture, facility, process, and other such activities, or a combination thereof. These plurality of query operations for emissions inventory assessments 1301 generated by the Reports Generator Data Processing System 1302 that may be executed by an embodiment of the system 100 are useful for determining the emissions position, based upon the actual emissions generated, of any entity, subsidiary, joint venture, facility, process, and other such activities, or a combination thereof, which could be necessary, in some instances, for internal, regulatory or voluntary compliance assessments.

The pluralities of query operations performed by the reports generator data processing system 1402 include, but are not limited to, the systems and subsystems described hereafter. Unless stated, the following methods are not necessarily performed in any particular order.

The emissions data for a given enterprise entity does not necessarily have to be stored in the application datastores but can be created from other subordinate enterprise levels, and due to the architecture of the system 100, can be dynamically created for monthly, quarterly, annual and other time periods while reflecting the given time periods complete enterprise structure, percent ownerships, and ownership rules system. The ownership percentages for each enterprise entity are adjusted by percent ownership rules sets applied to each enterprise entity, and are promulgated up through the different enterprise levels and applied to the different emissions weight values. The different emissions weights that are recorded in the system are also revaluated by multiplying emissions weights by a common product equivalent to ensure a common data consistency between different emissions. The individual emissions weights are aggregated for the given time periods to formulate a total emissions value. In addition, the system 100 can similarly promulgate different future inventory scenarios to generate and compare projected ‘business as usual’ projections as well as different ‘what if’ scenarios to provide information to users of the system 100 that analyzes potential futures for the said enterprise entity.

The Emissions Inventory Data Processing System 1304 constructs the historic emission inventory datasets one time period at a time. Within this system, the Historic Emissions Subsystem 1312 locates and analyzes all the correct data for each individual emission and emissions type for each time period. This selection process is instructed by the Inventory Aggregation Control Subsystem 1314 and the Record Period Administration Subsystem 1310 of the Administration Data Processing System 1303 which provides the Historic Emissions Subsystem 1312 the correct subordinate level locations to retrieve the datasets from and for which time periods that the data is applicable. As the data is retrieved, each individual record is filtered through the Entity Ownership Subsystems 1321 of the Non-Emissions Entity Data Processing System 1303 where the data is transformed and revalued to reflect all ownership percentages and rule sets at each level to the enterprise for the respective individual time periods. Each data record for emissions that have a common weight standard is converted to a weighted equivalent via the Emissions Conversion Factors Subsystem 1309 of the Administration Data Processing System 1303.

The Emissions Inventory Data Processing System 1304 constructs the projected emissions inventory datasets for user or system instructed future years. Within this system, the Projected Emissions Subsystem 1313 selects, compares, and aggregates all the correct data one time period at a time from the scenario datasets specified as the ‘default’ datasets or if instructed, from other ‘what if’ datasets. This selection process is driven by the Inventory Aggregation Control Subsystem 1314 and the Record Period Administration Subsystem 1310 of the Administration Data Processing System 1303 which provides the Projected Emissions Subsystem 1313 the correct subordinate level locations, based on the previous year's last known enterprise structure, to retrieve the datasets from. As the data is retrieved, each individual record set is filtered through the Entity Ownership Subsystems 1321 of the Non-Emissions Entity Data Processing System 1303 where the data is analyzed, transformed, and revalued to reflect all ownership percentages and rule sets at each enterprise level for the respective individual time periods. Each data record set for emissions that have a common weight standard is converted to a weighted equivalent via the Emissions Conversion Factors Subsystem 1309 of the Administration Data Processing System 1303.

The Reports Generator Data Processing Systems 1302 combines the multitude of datasets constructed by the Emissions Inventory Data Processing System 1304 into a plurality of Emissions Inventory Assessments 1301.

All datasets are compared, filtered, and formatted by the System Regulations Subsystem 1311 of the Administration Data Processing System 1303 to properly characterize the data according to user set metrics and measurements such as weight units, currency types, and number of decimal places. The reports and visual outputs are generated on a number of levels to present assessments including, but not limited to, different emission weight comparisons over time, including monthly, quarterly, or annual intervals, showing either emissions weight or common weight equivalencies; future emissions position comparisons over time reflecting different ‘what if’ scenarios for specific emissions or for the total emissions of all emissions combined using common weight equivalencies; a baseline of emissions for any historic years based on current enterprise ownership structures or projected future enterprise ownership structures. The displayed reports generated by the Reports Generator Data Processing Systems 1302 include, but are not limited to, visual outputs such as textual outputs and table formats, pie graphs, bar charts, line graphs, or a combination thereof.

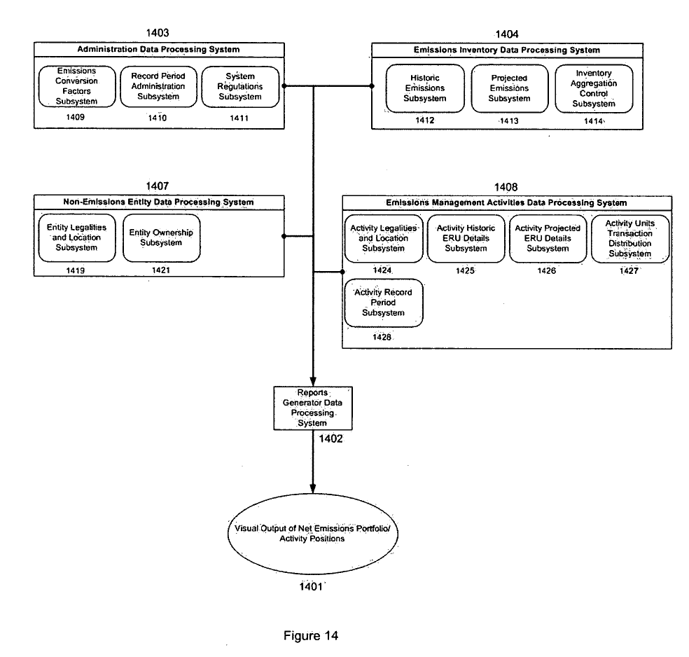

Referring to FIG. 14, this block diagram illustrates the methods and systems that take part in the plurality of query operations to analyze net emissions portfolio positions in relation to emissions management activity positions that may be executed by an embodiment of the system 100 for a given enterprise entity which consists of an entity, subsidiary, joint venture, facility, process, and other such activities, or a combination thereof. These plurality of query operations for net emissions portfolio/activity positions generated by the Reports Generator Data Processing System 1402 that may be executed by an embodiment of the system 100 are useful for determining the net emissions position of any entity, subsidiary, joint venture, facility, process, and other such activities, or a combination thereof, taking into account any activities or investments that would result in a net reduction in emissions position for a given portfolio or activity, which could be necessary, in some instances, for internal, regulatory or voluntary compliance assessments.

The pluralities of query operations performed by the reports generator data processing system 1402, include, but are not limited to, the systems and subsystems described hereafter. Unless stated, the following methods are not necessarily performed in any particular order.

The emissions data for a given enterprise entity do not necessarily have to be stored in the application datastores, but can be created from other subordinate levels of the enterprise and due to the architecture of the system 100, can be dynamically created for monthly, quarterly, annual and other time periods while reflecting the given time periods complete enterprise structure, percent ownerships, and ownership rules system. The ownership percentages for each enterprise entity are adjusted by percent ownership rules applied to each enterprise entity and are promulgated up through the different enterprise levels and applied to the different emissions weight values. The different emissions weights that are recorded in the system are also revaluated by multiplying emissions weights by a common product equivalent to ensure a common data consistency between different emissions. The individual emissions weights are aggregated for the given time periods to formulate a total emissions value. In addition, the system 100 can similarly promulgate different future inventory scenarios to generate and compare projected ‘business as usual’ projections as well as different ‘what if’ scenarios to provide users of the system 100 with information which analyzes potential futures for the said entity.

The Emissions Inventory Data Processing System 1404 constructs the historic emissions inventory datasets one time period at a time. Within this system, the Historic Emissions Subsystem 1412 locates and analyzes all the correct data for each individual emission and emission type for each time period. This selection process is instructed by the Inventory Aggregation Control Subsystem 1414 and the Record Period Administration Subsystem 1410 of the Administration Data Processing System 1403 which provides the Historic Emissions Subsystem 1412 the correct subordinate level locations to retrieve the datasets from and for which time periods that the data is applicable. As the data is retrieved, each individual record is filtered through the Entity Ownership Subsystems 1421 of the Non-Emissions Entity Data Processing System 1403 where the data is analyzed, transformed, and revalued to reflect all ownership percentages and rule sets at each enterprise level for the respective individual time periods. Each data record for emissions that have a common weight standard is converted to a weighted equivalent via the Emissions Conversion Factors Subsystem 1409 of the Administration Data Processing System 1403.

The Emissions Inventory Data Processing System 1404 constructs the projected emissions inventory datasets for user or system instructed future years. Within this system, the Projected Emissions Subsystem 1413 selects, compares, and aggregates all the correct data one time period at a time from the scenario datasets specified as the ‘default’ datasets or if instructed, from other ‘what if’ datasets. This selection process is driven by the Inventory Aggregation Control Subsystem 1414 and the Record Period Administration Subsystem 1410 of the Administration Data Processing System 1403 which provides the Projected Emissions Subsystem 1413 the correct subordinate level locations, based on the previous year's last known enterprise structure, to retrieve the datasets from. As the data is retrieved, each individual record set is filtered through the Entity Ownership Subsystems 1421 of the Non-Emissions Entity Data Processing System 1403 where the data is transformed and revalued to reflect all ownership percentages and rule sets at each enterprise level for the respective individual time periods. Each data record set for emissions that have a common weight standard is converted to a weighted equivalent via the Emissions Conversion Factors Subsystem 1409 of the Administration Data Processing System 1403.

The emissions management activity data for a given enterprise entity does not necessarily have to be owned directly by that entity, but may be owned by subordinate enterprise levels. Due to the architecture of the system 100, all activity data retrieved will be revaluated to reflect the complete enterprise structure, percent ownerships, and ownership rules system to which the percent ownerships of the activity are adjusted for any given time period. In addition, the time periods for a given year for a given activity may not match the time periods for other activities or the time period for the emissions and enterprise structure data. The architecture of the system 100 analyzes, correlates, and aggregates these time periods into a common time period for similar types of data by correlating data of lesser detailed time periods with the last applicable relational time period of the more detailed time period or by correlating more detailed time period data with encompassing lesser detailed time period data.

Different emissions management activities may consist of different combinations of emission focuses. The different emissions that can be recorded in the system have different common product equivalencies and will be revaluated to ensure data consistency. In addition, the system 100 can promulgate different future emissions management activity scenarios to generate and compare projected ‘business as usual’ projections as well as different ‘what if’ scenarios to provide users of the system 100 with information which analyzes potential futures for the said entity.

The Emissions Management Activities Data processing System 1408 constructs the historic reduction unit datasets one time period at a time. Within this system, the Activity Historic ERU Details Subsystem 1425 locates all the correct data for each individual emission and emissions types and for each time period and for each user or system selected activity. These datasets are constrained by the selection boundaries and types provided by the Activities Legalities and Location Subsystem 1424 and by the Activity Record Period Subsystem 1428 which instructs the subsystem on the correct time periods that the data is applicable. As the data is constructed, each individual record set is filtered through the Entity Ownership Subsystems 1421 of the Non-Emissions Entity Data Processing System 1403 where the data is analyzed, transformed and revalued to reflect all ownership percentages and rule sets at each enterprise level for the respective individual time periods. The Activity Record Period Subsystem 1428 maintains different associated time periods for the records associated with the management activities and the records associated with the Entity Ownership Subsystems 1421, by controlling the conversions and decision of paths to promulgate the datasets through the same time period. Each data piece is converted to a weighted equivalent via the Emissions Conversion Factors Subsystem 1409 of the Administration Data Processing System 1400. The Activity Units Transaction Distribution Subsystem 1427 constructs a complete set of annualized reduction units that have a different distribution path and adjust the reduction unit datasets accordingly.

The Emissions Management Activities Data processing System 1408 constructs the projected reduction unit datasets for any user or system instructed future years. Within this system, the Activity Projected ERU Details Subsystem 1425 selects, compares, and aggregates all the correct data one time period at a time from the scenario datasets specified as the ‘default’ datasets or if instructed, from other ‘what if’ datasets for each user or system selected activity. These datasets are constrained by the selection boundaries and types instructed by the Activities Legalities and Location Subsystem 1424 and by the Activity Record Period Subsystem 1428 which instructs the subsystem on the correct time periods that the data is applicable. As the data is constructed, each individual record set is filtered through the Entity Ownership Subsystems 1421 of the Non-Emissions Entity Data Processing System 1403 where the data is transformed and revalued to reflect all ownership percentages and rule sets at each enterprise level for the respective individual time periods. Each data record set for emissions that have a common weight standard is converted to a weighted equivalent via the Emissions Conversion Factors Subsystem 1409 of the Administration Data Processing System 1403. The Activity Units Transaction Distribution Subsystem 1427 constructs a complete set of annualized reduction units that have a different distribution path and adjust the reduction unit datasets accordingly.

The Reports Generator Data Processing Systems 1402 combines the multitude of datasets constructed by the Emissions Inventory Data Processing System 1404 and the Emissions Management Activities Data Processing System 1408 into a plurality of Net Emissions Inventory Portfolio/Activity Positions 1401.

All datasets are compared, filtered and formatted by the System Regulations Subsystem 1411 of the Administration Data Processing System 1403 to properly characterize the data according to user set metrics and measurements. The reports and visual outputs are generated on a number of levels to present net emission positions, including, but not limited to, different emissions weight versus adjusted emissions weight comparisons over time, including monthly, quarterly, or annual intervals, showing either emissions weight or common weight equivalencies; future emissions versus net emissions position comparisons over time reflecting different ‘what if’ scenarios for specific emissions or for the total of all emissions combined using common weight equivalencies; a baseline of emissions versus net emissions for any historic years based on current enterprise ownership structures or projected future enterprise ownership structures; prospective net emissions over time in relation to prospective and/or divested activities. Net emissions over time in relation to user or system distributed bankable emissions reductions for given time periods. The report display types generated by the Reports Generator Data Processing Systems 1402 include, but are not limited to, visual outputs such as textual outputs and table formats, pie graphs, bar charts, line graphs, or a combination thereof.

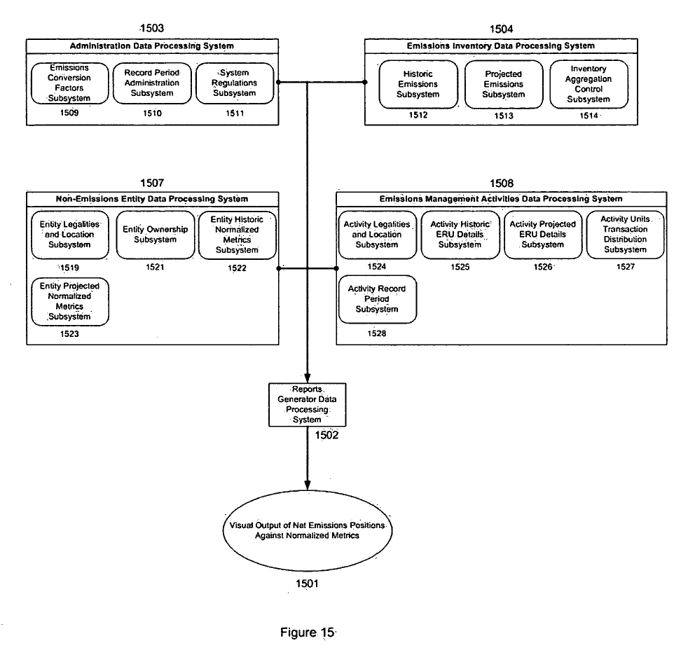

Referring to FIG. 15, this block diagram illustrates the methods and systems that take part in the plurality of query operations to analyze normalized net emissions portfolio positions in relation to normalized emissions management activity positions that may be executed by an embodiment of the system 100 for a given enterprise entity which consists of an entity, subsidiary, joint venture, facility, process, and other such activities, or a combination thereof. These plurality of query operations for Net Emissions Positions Against Normalized Metrics 1501 generated by the Reports Generator Data Processing System 1502 that may be executed by an embodiment of the system 100 are useful for determining the net emissions position of any entity, subsidiary, joint venture, facility, process, and the like, or a combination thereof, taking into account any activities or investments that would result in a net reduction in emissions position for a given portfolio or activity, and measured against data, including, but not limited to, financial or production-based data, which could be necessary, in some instances, for internal, regulatory or voluntary compliance assessments.

The pluralities of query operations performed by the reports generator data processing system 1502 include, but are not limited to, the systems and subsystems described hereafter. Unless stated, the following methods are not necessarily performed in any particular order.

The emissions data for a given enterprise entity does not necessarily have to be stored in the application datastores but can be created from subordinate enterprise levels and due to the architecture of the system 100, can be dynamically created for monthly, quarterly, annual and other time periods while reflecting the given time periods complete enterprise structure, percent ownerships, and ownership rules system. The ownership percentages for each enterprise entity are adjusted by percent ownership rules applied to each enterprise entity and are promulgated up through the different enterprise levels and applied to the different emissions weight values. The different emissions weights that are recorded in the system are also revaluated by multiplying emissions weights by a common product equivalent to ensure a common data consistency between different emissions. The individual emissions weights are aggregated for the given time periods to formulate a total emissions value. In addition, the system 100 can similarly promulgate different future inventory scenarios to generate and compare projected ‘business as usual’ projections as well as different ‘what if’ scenarios to provide information to users of the system 100 with information which analyzes potential futures for the said entity.

The Emissions Inventory Data Processing System 1504 constructs the historic emissions inventory datasets one time period at a time. Within this system, the Historic Emissions Subsystem 1512 locates and analyzes all the correct data for each individual emission and emissions type for each time period. This selection process is instructed by the Inventory Aggregation Control Subsystem 1514 and the Record Period Administration Subsystem 1510 of the Administration Data Processing System 1503 which provides the Historic Emissions Subsystem 1512 the correct subordinate level locations to retrieve the datasets from and for which time periods that the data is applicable. As the data is retrieved, each individual record is filtered through the Entity Ownership Subsystems 1521 of the Non-Emissions Entity Data Processing System 1503 where the data is transformed and revalued to reflect all ownership percentages and rule sets at each enterprise level for the respective individual time periods. Each data record for emissions that have a common weight standard is converted to a weighted equivalent via the Emissions Conversion Factors Subsystem 1509 of the Administration Data Processing System 1503.

The Emissions Inventory Data Processing System 1504 constructs the projected emissions inventory datasets for user or system instructed future years. Within this system, the Projected Emissions Subsystem 1513 selects, compares, and aggregates all the correct data one time period at a time from the scenario datasets specified as the ‘default’ datasets or if instructed, from other ‘what if’ datasets. This selection process is driven by the Inventory Aggregation Control Subsystem 1514 and the Record Period Administration Subsystem 1510 of the Administration Data Processing System 1503 which provides the Projected Emissions Subsystem 1513 the correct subordinate level locations, based on the previous year's last known enterprise structure, to retrieve the datasets from. As the data is retrieved, each individual record set is filtered through the Entity Ownership Subsystems 1521 of the Non-Emissions Entity Data Processing System 1503 where the data is transformed and revalued to reflect all ownership percentages and rule sets at each enterprise level for the respective individual time periods. Each data record set for emissions that have a common weight standard is converted to a weighted equivalent via the Emissions Conversion Factors Subsystem 1509 of the Administration Data Processing System 1503.

The emissions management activity data for a given enterprise entity does not necessarily have to be owned directly by that entity but may be owned by subordinate enterprise levels. Due to the architecture of the system 100, all activity data retrieved will be revaluated to reflect the complete enterprise structure, percent ownerships, and ownership rules system to which the percent ownerships of the activity are adjusted for any given time period. In addition, the time periods for a given year for a given activity may not match the time periods for other activities or the time period for the emissions and enterprise structure data. The architecture of the system 100 correlates and aggregates these time periods into a common time period for similar types of data by correlating data of lesser detailed time periods with the last applicable relational time period of the more detailed time period or by correlating more detailed time period data with encompassing lesser detailed time period data.

Different emissions management activities may consist of different combinations of emission focuses. The different emissions that can be recorded in the system have different common product equivalencies and will be revaluated to ensure data consistency. In addition, the system 100 can promulgate different future emissions management activity scenarios to generate and compare projected ‘business as usual’ projections as well as different ‘what if’ scenarios to provide users of the system 100 with information which analyzes potential futures for the said entity.

The Emissions Management Activities Data Processing System 1508 constructs the historic reduction unit datasets one time period at a time. Within this system, the Activity Historic ERU Details Subsystem 1525 locates and analyzes all the correct data for each individual emission and emissions types and for each time period and for each user or system selected activity. These datasets are constrained by the selection boundaries and types provided by the Activities Legalities and Location Subsystem 1524 and by the Activity Record Period Subsystem 1528 which instructs the subsystem on the correct time periods that the data is applicable. As the data is constructed, each individual record set is filtered through the Entity Ownership Subsystems 1521 of the Non-Emissions Entity Data Processing System 1503 where the data is analyzed, transformed, and revalued to reflect all ownership percentages and rule sets at each enterprise level for the respective individual time periods. The Activity Record Period Subsystem 1528 maintains different associated time periods for the records associated with the management activities and the records associated with the Entity Ownership Subsystems 1521, by controlling the conversions and decision of paths to promulgate the datasets through the same time period. Each data piece is converted to a weighted equivalent via the Emissions Conversion Factors Subsystem 1509 of the Administration Data Processing System 1500. The Activity Units Transaction Distribution Subsystem 1527 constructs a complete set of annualized reduction units that have a different distribution path and adjust the reduction unit datasets accordingly.

The Emissions Management Activities Data Processing System 1508 constructs the projected reduction unit datasets for any user or system instructed future years. Within this system, the Activity Projected ERU Details Subsystem 1525 selects, compares, and aggregates all the correct data one time period at a time from the scenario datasets specified as the ‘default’ datasets or if instructed, from other ‘what if’ datasets for each user or system selected activity. These datasets are constrained by the selection boundaries and types instructed by the Activities Legalities and Location Subsystem 1524 and by the Activity Record Period Subsystem 1528 which instructs the subsystem on the correct time periods that the data is applicable. As the data is constructed, each individual record set is filtered through the Entity Ownership Subsystems 1521 of the Non-Emissions Entity Data Processing System 1503 where the data is transformed and revalued to reflect all ownership percentages and rule sets at each enterprise level for the respective individual time periods. Each data record set for emissions that have a common weight standard is converted to a weighted equivalent via the Emissions Conversion Factors Subsystem 1509 of the Administration Data Processing System 1503. The Activity Units Transaction Distribution Subsystem 1527 constructs a complete set of annualized reduction units that have a different distribution path and adjust the reduction unit datasets accordingly.

The different metrics that can be recorded in the system 100 can be used to normalize historic and future emissions and net emissions positions. Types of these normalized metrics include, but are not limited to, gross revenue, net revenue, and product yield metrics. The system 100 can promulgate different future normalized metric scenarios to generate and compare projected ‘business as usual’ projections as well as different ‘what if’ scenarios to provide users of the system 100 with information which analyzes potential normalized emission and net emission positions.

The Non-Emissions Entity Data Processing System 1507 constructs the historic normalized metric datasets one time period at a time. Within this system, the Entity Historic Normalized Metric Subsystem 1522 locates and analyzes all the correct data for the given enterprise level for each time period. This selection process is instructed by the Record Period Administration Subsystem 1510 of the Administration Data Processing System 1503 which provides the Entity Historic Normalized Metric Subsystem 1522 the time periods that the data is applicable.

The Emissions Non-Emissions Entity Data Processing System 1507 constructs the projected emissions inventory datasets for user or system instructed future years. Within this system, the Entity Projected Normalized Metrics Subsystem 1523 selects and compares all the correct data one time period at a time from the scenario datasets specified as the ‘default’ datasets or if instructed, from other ‘what if’ datasets.

The Reports Generator Data Processing Systems 1502 combines the multitude of datasets constructed by the Emissions Inventory Data Processing System 1504, the Emissions Management Activities Data Processing System 1508 and the Emissions Non-Emissions Entity Data Processing System 1507 into a plurality of Net Emissions Inventory Positions Against Normalized Metrics 1501.

All datasets are compared, filtered, and formatted by the System Regulations Subsystem 1511 of the Administration Data Processing System 1503 to properly characterize the data according to user set metrics and measurements. The reports and visual outputs are generated on a number of levels to present normalized net emission positions including, but not limited to, different normalized emissions weight versus adjusted normalized emissions weight comparisons over time, including monthly, quarterly, or annual intervals, showing either normalized emissions weight or normalized common weight equivalencies; future normalized emissions versus net normalized emissions position comparisons over time reflecting different ‘what if’ scenarios for specific emissions or for the total of all emissions combined using common weight equivalencies; a baseline of normalized emissions versus normalized net emissions for any historic years based on current enterprise ownership structures or projected future enterprise ownership structures; prospective net emissions over time in relation to prospective and/or divested activities. Normalized net emissions over time in relation to user or system distributed bankable emissions reductions for given time periods. The report display types generated by the Reports Generator Data Processing Systems 1502 include, but are not limited to, visual outputs such as textual outputs and table formats, pie graphs, bar charts, line graphs, or a combination thereof.

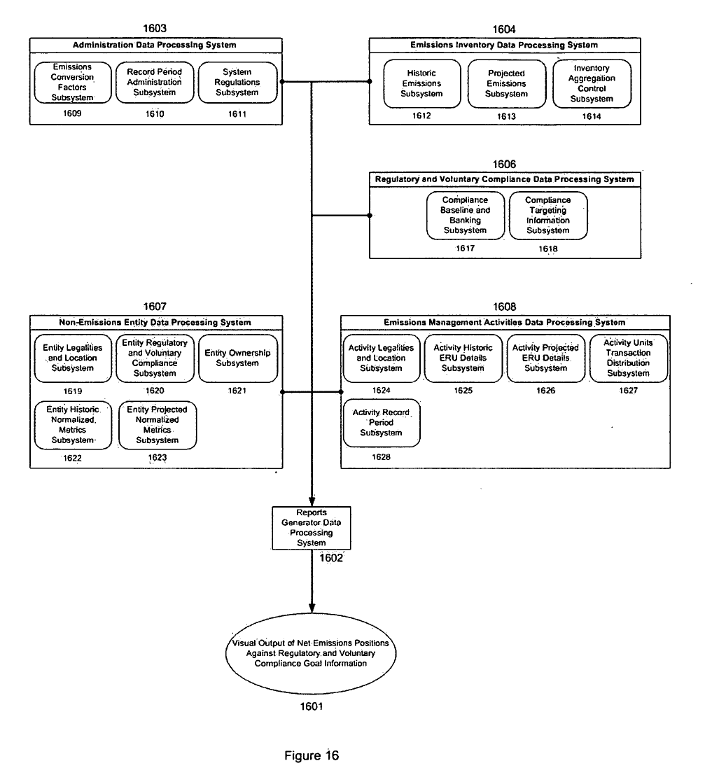

Referring to FIG. 16, this block diagram illustrates the methods and systems that take part in the plurality of query operations to examine normalized or absolute net emissions positions against regulatory or voluntary environmental program goals that may be executed by an embodiment of the system 100 for a given enterprise entity which consists of an entity, subsidiary, joint venture, facility, process, and the like, or a combination thereof. These plurality of query operations for Net Emissions Positions Against Regulatory and Voluntary Compliance Goal Information 1601 generated by the Reports Generator Data Processing System 1602 that may be executed by an embodiment of the system 100 are useful for determining the net emissions position of any entity, subsidiary, joint venture, facility, process, and other such activities, or a combination thereof, taking into account any activities or investments that would result in a net reduction in emissions position for a given portfolio or activity, and measured against data, including, but not limited to, regulatory requirements, voluntary compliance goals, or internally-derived goals, which could be necessary, in some instances, for internal, regulatory or voluntary compliance reporting.

The pluralities of query operations performed by the reports Generator Data Processing System 1602 include, but are not limited to, the systems and subsystems described hereafter. Unless stated, the following methods are not necessarily performed in any particular order.

Regulatory and voluntary environmental program goals are dynamically calculated using the baselines and targets defined in the Regulatory and Voluntary Compliance Data Processing System 1606 and from the enterprise structure of a given enterprise entity for the applicable time periods. The system 100 analyzes the enterprise structure, percent ownerships, and ownership rules system to which the percent ownerships of the activity are adjusted, for the base year(s) and the target year(s) and make a determination on which enterprise levels and at what quantity to aggregate baselines. Multiple baselines are averaged or filtered by minimums or maximums depending on how the environmental program goal was defined. Baselines are adjusted by the reduction percentages for a given environmental program goal.

The banking system incorporated when comparing net emissions against regulatory and voluntary environmental program goals stores and aggregates system or user selected emissions management activity reductions for the years defined for a given environmental program goal and applies the totals to the net inventory at the defined compliance goal target year.

The Regulatory and Voluntary Compliance Data Processing System 1606 instructs the Historic Emissions Subsystem 1612 on constructing baseline emission positions using data defined in the Compliance Baseline and Banking System 1617 for a given enterprise entity. The Historic Emissions Subsystem 1612 locates and analyzes all the correct data for each individual emission and emissions type for the time periods applicable to the baseline(s) for the given environmental program goal. This selection process is instructed by the Inventory Aggregation Control Subsystem 1614 and the Record Period Administration Subsystem 1610 of the Administration Data Processing System 1603 along with the Compliance Baseline and Banking System 1617 which provides the Historic Emissions Subsystem 1612 the correct subordinate level locations to retrieve the datasets from based on factors including, but not limited to, current and past enterprise structures, operational time periods, ownership time periods, and enterprise entity procurement and divesture points. As the data is retrieved, each individual record is filtered through the Entity Ownership Subsystems 1621 of the Non-Emissions Entity Data Processing System 1603 where the data is analyzed, transformed, and revalued to reflect all ownership percentages and rule sets at each enterprise level for each enterprise entity as it is structured in the target year of the compliance goal. Each data record for emissions that have a common weight standard is converted to a weighted equivalent via the Emissions Conversion Factors Subsystem 1609 of the Administration Data Processing System 1603. Multiple baselines are either averaged or filtered by minimum or maximum values depending on set parameters for a given environmental program goal.

The emissions data for a given enterprise entity does not necessarily have to be stored in the application datastores but can be created from subordinate enterprise levels and due to the architecture of the system 100, can be dynamically created for monthly, quarterly, and annual time periods while reflecting the given time periods complete enterprise structure, percent ownerships, and ownership rules system. The ownership percentages for each enterprise entity are adjusted by percent ownership rules applied to each enterprise entity and are promulgated up through the different enterprise levels and applied to the different emissions weight values. The different emissions weights that are recorded in the system are also revaluated by multiplying emissions weights by a common product equivalent to ensure a common data consistency between different emissions. The individual emissions weights are aggregated for the given time periods to formulate a total emissions value. In addition, the system 100 can similarly promulgate different future inventory scenarios to generate and compare projected ‘business as usual’ projections as well as different ‘what if’ scenarios to provide information to users of the system 100 with information which analyzes potential futures for the said entity.

The Emissions Inventory Data Processing System 1604 constructs the historic emissions inventory datasets one time period at a time. Within this system, the Historic Emissions Subsystem 1612 locates and compares all the correct data for each individual emission and emissions type for each time period. This selection process is instructed by the Inventory Aggregation Control Subsystem 1614 and the Record Period Administration Subsystem 1610 of the Administration Data Processing System 1603 which provides the Historic Emissions Subsystem 1612 the correct subordinate level locations to retrieve the datasets from and for which time periods that the data is applicable. As the data is retrieved, each individual record is filtered through the Entity Ownership Subsystems 1621 of the Non-Emissions Entity Data Processing System 1603 where the data is transformed and revalued to reflect all ownership percentages and rule sets at each enterprise level for the respective individual time periods. Each data record for emissions that have a common weight standard is converted to a weighted equivalent via the Emissions Conversion Factors Subsystem 1609 of the Administration Data Processing System 1603.

The Emissions Inventory Data Processing System 1604 constructs the projected emissions inventory datasets for user or system instructed future years. Within this system, the Projected Emissions Subsystem 1613 selects, compares, and aggregates all the correct data one time period at a time from the scenario datasets specified as the ‘default’ datasets or if instructed, from other ‘what if’ datasets. This selection process is driven by the Inventory Aggregation Control Subsystem 1614 and the Record Period Administration Subsystem 1610 of the Administration Data Processing System 1603 which provides the Projected Emissions Subsystem 1613 the correct subordinate level locations, based on the previous year's last known enterprise structure, to retrieve the datasets from. As the data is retrieved, each individual record set is filtered through the Entity Ownership Subsystems 1621 of the Non-Emissions Entity Data Processing System 1603 where the data is transformed and revalued to reflect all ownership percentages and rule sets at each enterprise level for the respective individual time periods. Each data record set for emissions that have a common weight standard is converted to a weighted equivalent via the Emissions Conversion Factors Subsystem 1609 of the Administration Data Processing System 1603.

The emissions management activity data for a given enterprise entity does not necessarily have to be owned directly by that entity but may be owned by subordinate entities. Due to the architecture of the system 100, all activity data retrieved will be revaluated to reflect the complete enterprise structure, percent ownerships, and ownership rules system to which the percent ownerships of the activity are adjusted for any given time period. In addition, the time periods for a given year for a given activity may not match the time periods for other activities or the time period for the emissions and enterprise structure data. The architecture of the system 100 correlates and aggregates these time periods into similar types of data by correlating data of lesser detailed time periods with the last applicable relational time period of the more detailed time period or by correlating more detailed time period data with encompassing lesser detailed time period data.

Different emissions management activities may consist of different combinations of emission focuses. The different emissions that can be recorded in the system have different common product equivalencies and will be revaluated to ensure data consistency. In addition, the system 100 can promulgate different future emissions management activity scenarios to generate and compare projected ‘business as usual’ projections as well as different ‘what if’ scenarios to provide users of the system 100 with information which analyzes potential futures for the said entity.

The Emissions Management Activities Data processing System 1608 constructs the historic reduction unit datasets one time period at a time. Within this system, the Activity Historic ERU Details Subsystem 1625 locates all the correct data for each individual emission and emissions types and for each time period and for each user or system selected activity. These datasets are constrained by the selection boundaries and types provided by the Activities Legalities and Location Subsystem 1624 and by the Activity Record Period Subsystem 1628 which instructs the subsystem on the correct time periods that the data is applicable. As the data is constructed, each individual record set is filtered through the Entity Ownership Subsystems 1621 of the Non-Emissions Entity Data Processing System 1603 where the data is analyzed, transformed, and revalued to reflect all ownership percentages and rule sets at each enterprise level for the respective individual time periods. The Activity Record Period Subsystem 1628 maintains different associated time periods for the records associated with the management activities and the records associated with the Entity Ownership Subsystems 1621, by controlling the conversions and decision of paths to promulgate the datasets through the same time period. All activity emissions reduction units are analyzed against the Regulatory and Voluntary Compliance Data Processing System 1606 to determine if they are ‘bankable’. If so, the given emission reduction units might not be applied to the given time period they were generated from, but to the target year of the said environmental program goal. Each data piece is converted to a weighted equivalent via the Emissions Conversion Factors Subsystem 1609 of the Administration Data Processing System 1600. The Activity Units Transaction Distribution Subsystem 1627 constructs a complete set of annualized reduction units that have a different distribution path and adjust the reduction unit datasets accordingly.

The Emissions Management Activities Data Processing System 1608 constructs the projected reduction unit datasets for any user or system instructed future years. Within this system, the Activity Projected ERU Details Subsystem 1625 selects and aggregates all the correct data one time period at a time from the scenario datasets specified as the ‘default’ datasets or if instructed, from other ‘what if’ datasets for each user or system selected activity. These datasets are constrained by the selection boundaries and types instructed by the Activities Legalities and Location Subsystem 1624 and by the Activity Record Period Subsystem 1628 which instructs the subsystem on the correct time periods that the data is applicable. As the data is constructed, each individual record set is filtered through the Entity Ownership Subsystems 1621 of the Non-Emissions Entity Data Processing System 1603 where the data is transformed and revalued to reflect all ownership percentages and rule sets at each enterprise level for the respective individual time periods. All activity emissions reduction units are analyzed against the Regulatory and Voluntary Compliance Data Processing System 1606 to determine if they are ‘bankable’. If so, the given emissions reduction units might not be applied to the given time period they were generated from, but to the target year of the said environmental program goal. Each data record set for emissions that have a common weight standard is converted to a weighted equivalent via the Emissions Conversion Factors Subsystem 1609 of the Administration Data Processing System 1603. The Activity Units Transaction Distribution Subsystem 1627 constructs a complete set of annualized reduction units that have a different distribution path and adjust the reduction unit datasets accordingly.

The different metrics recorded in the system 100 can be used to normalize historic, future, and net emissions positions. Types of these normalized metrics include, but are not limited to, gross revenue, net revenue, and product yield metrics. The system 100 can promulgate different future normalized metric scenarios to generate and compare projected ‘business as usual’ projections as well as different ‘what if’ scenarios to assist users of the system 100 to analyze potential normalized emission and net emission positions. For example, viewing emissions data in metric tonnes per US dollar.

The Non-Emissions Entity Data Processing System 1607 constructs the historic normalized metric datasets one time period at a time. Within this system, the Entity Historic Normalized Metric Subsystem 1622 locates all the correct data for the given enterprise level for each time period. This selection process is instructed by the Record Period Administration Subsystem 1610 of the Administration Data Processing System 1603 which provides the Entity Historic Normalized Metric Subsystem 1622 the time periods that the data is applicable.

The Emissions Non-Emissions Entity Data Processing System 1607 constructs the projected emissions inventory datasets for user or system instructed future years. Within this system, the Entity Projected Normalized Metrics Subsystem 1623 selects all the correct data one time period at a time from the scenario datasets specified as the ‘default’ datasets or if instructed, from other ‘what if’ datasets.

The Reports Generator Data Processing Systems 1602 combines the multitude of datasets constructed by the Emissions Inventory Data Processing System 1604, the Emissions Management Activities Data Processing System 1608 and the Emissions Non-Emissions Entity Data Processing System 1607, and the Voluntary Compliance Data Processing System 1606 into a plurality of normalized and absolute Net Emissions Inventory Positions Against Regulatory and Voluntary Compliance Goal Information 1601.

All datasets are filtered and formatted by the System Regulations Subsystem 1611 of the Administration Data Processing System 1603 to properly characterize the data according to user set metrics and measurements. The reports and visual outputs are generated on a number of levels to present net emission positions versus environmental program goals including, but not limited to, net emission reduction inventories versus environmental program goals; normalized net emission reduction inventories versus environmental program goals; emissions baselines for any base year(s) compliant with environmental program goals; normalized emissions baselines for any base year(s) compliant with environmental program goals; annualized net emissions gap analysis versus environmental program goals; annualized normalized net emissions gap analysis versus environmental program goals; where all the preceding report types are based on current enterprise ownership structures or projected future enterprise ownership structures; prospective net emissions over time in relation to potential prospective and/or divested activities; and net emissions over time in relation to user or system distributed bankable emissions reductions for given time periods. The report display types generated by the Reports Generator Data Processing Systems 1602 include, but are not limited to, visual outputs such as textual outputs and table formats, pie graphs, bar charts, line graphs, or a combination thereof.

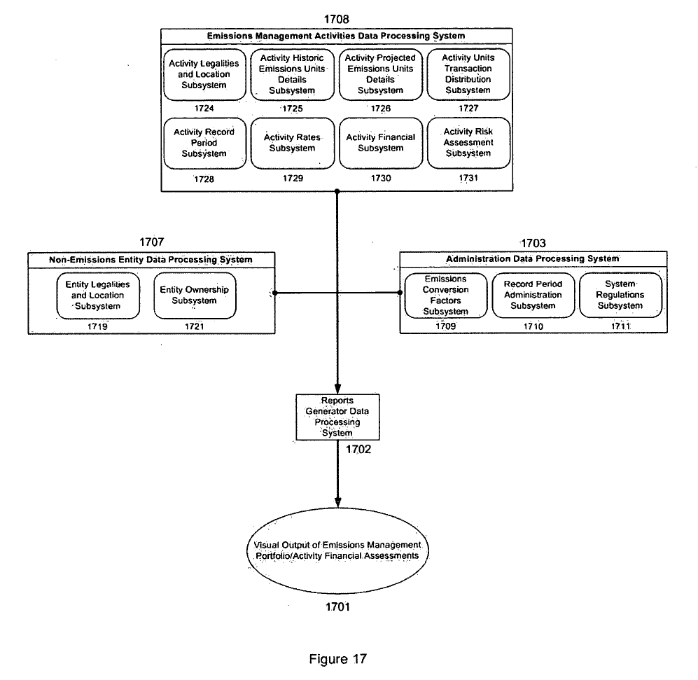

Referring to FIG. 17, this block diagram illustrates the methods and systems that take part in the plurality of query operations to analyze emissions management portfolio/activity financial assessments that are executed by an embodiment of the system 100 for a given enterprise level which consists of an entity, subsidiary, joint venture, facility, process, and the like, or a combination thereof. These plurality of query operations for Emissions Management Portfolio/Activity Financial Assessments 1701 generated by the Reports Generator Data Processing System 1702 that may be executed by an embodiment of the system 100 are useful for determining the cost-effectiveness or asset positions of a portfolio or an individual activity for any entity, subsidiary, joint venture, facility, process, and other such activities, or a combination thereof, taking into account financial performance, which could be necessary, in some instances, for determining economically-viable program plans and activities.

The pluralities of query operations performed by the Reports Generator Data Processing System 1702 include, but are not limited to, the systems and subsystems described hereafter. Unless stated, the following methods are not necessarily performed in any particular order.

The emissions management activity data for a given enterprise entity does not necessarily have to be owned directly by that entity but may be owned by subordinate entities. Due to the architecture of the system 100, all activity data retrieved will be revaluated to reflect the complete enterprise structure, percent ownerships, and ownership rules system to which the percent ownerships of the activity are adjusted for any given time period. In addition, the time periods for a given year for a given activity may not match the time periods for other activities or the time period for the emissions and enterprise structure data. The architecture of the system 100 analyzes, correlates, and aggregates these time periods into a common time period for similar types of data by correlating data of lesser detailed time periods with the last applicable relational time period of the more detailed time period or by correlating more detailed time period data with encompassing lesser detailed time period data.

Different emissions management activities may consist of different combinations of emission focuses. The different emissions that can be recorded in the system have different common product equivalencies and will be revaluated to ensure data consistency. In addition, the system 100 can promulgate different future emissions management activity scenarios to generate and compare projected ‘business as usual’ projections as well as different ‘what if’ scenarios to assist users of the system 100 to analyze potential futures for the said entity. Combined with historic and potential emissions reduction unit transactions at fixed prices, the emissions reduction units generated by said activities have direct impacts on the financial assessments of those activities.

The Emissions Management Activities Data Processing System 1708 constructs the historic and projected costs and revenues associated with given activities. The Activity Financial Subsystem 1730 generates and compares costs and revenues for individual time periods maintained by the Activity Record Period Subsystem 1728 into totals for user or system selected time periods. These datasets are constrained by the selection boundaries and types provided by the Activities Legalities and Location Subsystem 1724 which instructs the subsystems activity ownership percentages for each given activity.

The Activity Units Transaction Distribution Subsystem 1727 correlates transacted emissions reduction units with the Activity Financial Subsystem 1730 to determine fixed price revenues that are aggregated with the other revenues calculated from the Activity Financial Subsystem 1730. Any fixed prices for generated emissions reduction units are correlated with the Activity Historic ERU Details Subsystem 1725 and the Activity Projected ERU Details Subsystem 1725 to generate fixed price costs that are aggregated with other costs generated by the Activity Financial Subsystem 1730. As the data is constructed, each individual record set is filtered through the Entity Ownership Subsystems 1721 of the Non-Emissions Entity Data Processing System 1703 where the data is analyzed, transformed and revalued to reflect all ownership percentages and rule sets at each enterprise level for the respective individual time periods.

The Activity Rates Subsystem 1729 maintains and manages financial rate data for a given activity. These financial rates include, but are not limited to, discount rates, user-defined risk rates, internal rate of return upper and lower bounds, and time value of money rates. These datasets are used within the Activity Financial Subsystem 1730 to generate discounted, risk-adjusted, and time value of money adjusted costs and revenue data sets.

The Activity Risk Assessment Subsystem 1731 maintains and manages activity risk data for a given emissions management activity record. This risk information includes informational data, including probabilities and impact values on financial and emissions reductions unit risks. The Activity Risk Assessment Subsystem 1731 uses these data sets to create Financial Risk Rates and Financial Values at Risk for a given activity where as the Activity Financial Subsystem 1730 calculates system generated risk adjusted cost and revenue values.

The Emissions Management Activities Data Processing System 1708 constructs the historic reduction unit datasets one time period at a time. Within this system, the Activity Historic ERU Details Subsystem 1725 locates all the correct data for each individual emission and emissions types and for each time period and for each user or system selected activity. These datasets are constrained by the selection boundaries and types provided by the Activities Legalities and Location Subsystem 1724 and by the Activity Record Period Subsystem 1728 which instructs the subsystem on the correct time periods that the data is applicable. As the data is constructed, each individual record set is filtered through the Entity Ownership Subsystems 1721 of the Non-Emissions Entity Data Processing System 1703 where the data is analyzed, transformed and revalued to reflect all ownership percentages and rule sets at each enterprise level for the respective individual time periods. The Activity Record Period Subsystem 1728 maintains different associated time periods for the records associated with the management activities and the records associated with the Entity Ownership Subsystems 1721, by controlling the conversions and decision of paths to promulgate the datasets through the same time period. Each data piece is converted to a weighted equivalent via the Emissions Conversion Factors Subsystem 1709 of the Administration Data Processing System 1700. The Activity Units Transaction Distribution Subsystem 1727 constructs a complete set of annualized reduction units that have a different distribution path and adjust the reduction unit datasets accordingly.

The Emissions Management Activities Data Processing System 1708 constructs the projected reduction unit datasets for any user or system instructed future years. Within this system, the Activity Projected ERU Details Subsystem 1725 selects, compares, and aggregates all the correct data one time period at a time from the scenario datasets specified as the ‘default’ datasets or if instructed, from other ‘what if’ datasets for each user or system selected activity. These datasets are constrained by the selection boundaries and types instructed by the Activities Legalities and Location Subsystem 1724 and by the Activity Record Period Subsystem 1728 which instructs the subsystem on the correct time periods that the data is applicable. As the data is constructed, each individual record set is filtered through the Entity Ownership Subsystems 1721 of the Non-Emissions Entity Data Processing System 1703 where the data is transformed and revalued to reflect all ownership percentages and rule sets at each enterprise level for the respective individual time periods. Each data record set for emissions that have a common weight standard is converted to a weighted equivalent via the Emissions Conversion Factors Subsystem 1709 of the Administration Data Processing System 1703. The Activity Units Transaction Distribution Subsystem 1727 constructs a complete set of annualized reduction units that have a different distribution path and adjust the reduction unit datasets accordingly.

The Reports Generator Data Processing Systems 1702 combines the multitude of datasets constructed by the Emissions Inventory Data Processing System 1704 and the Emissions Management Activities Data Processing System 1708 into a plurality of Emissions Management Portfolio/Activity Financial Assessments 1701.

All datasets are compared, filtered and formatted by the System Regulations Subsystem 1711 of the Administration Data Processing System 1703 to properly characterize the data according to user set metrics and measurements. The reports and visual outputs are generated on a number of levels to present financial assessments including, but not limited to, annualized cost and revenue comparison over time, including monthly, quarterly, or annual intervals where costs and revenues can be discounted, risk adjusted, or adjusted against the time value of money; future cost and revenue comparisons over time reflecting different ‘what if’ scenarios for specific emissions or for the total of all emissions combined using common weight equivalencies where costs and revenues can be discounted, risk adjusted, or adjusted against the time value of money; activity and portfolio values calculated by subtracting generated costs from generated revenues over time including monthly, quarterly, or annual intervals where costs and revenues can be discounted, risk adjusted, or adjusted against the time value of money; where all the preceding report types are based on current and historic enterprise ownership structures or projected future enterprise ownership structures; and prospective net emissions over time in relation to potential prospective and/or divested activities; percentage of detailed total cost apportioned to a specified detailed cost title; percentage of detailed total revenues apportioned to a specified detailed revenue title; total detail cost field consisting of the total costs of an emissions reduction project under the auspice of a specified detailed title; total detail revenue field consisting of the total revenues of an emissions reduction project under the auspice of a specified detailed title. The displayed reports generated by the Reports Generator Data Processing Systems 1702 include, but are not limited to, visual outputs such as textual outputs and table formats, pie graphs, bar charts, line graphs, or a combination thereof.

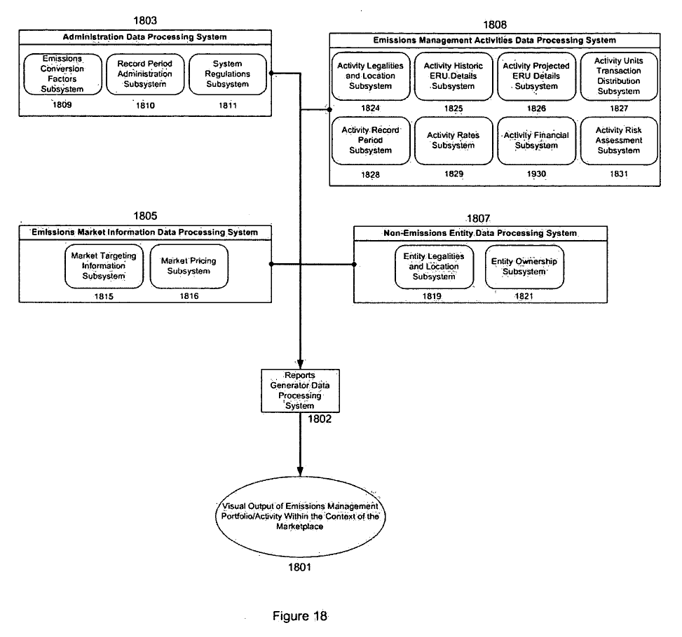

Referring to FIG. 18, this block diagram illustrates the methods and systems that function in the plurality of query operations to analyze emissions management portfolio/activity financial assessment comparison against market projection data that may be executed by an embodiment of the system 100 for a given enterprise entity which consists of an entity, subsidiary, joint venture, facility, process, and other such activities, or a combination thereof. These plurality of query operations for Emissions Management Portfolio/Activity Within the Context of the Marketplace 1801 generated by the Reports Generator Data Processing System 1802 that may be executed by an embodiment of the system 100 are useful for determining the cost-effectiveness or asset positions of a portfolio or an individual activity for any entity, subsidiary, joint venture, facility, process, and other such activities, or a combination thereof, taking into account financial performance and market prices and future price projections, which could be necessary, in some instances, for determining economically-viable program plans and activities.

The pluralities of query operations performed by the Reports Generator Data Processing System 1802 include, but are not limited to, the systems and subsystems described hereafter. Unless stated, the following methods are not necessarily performed in any particular order.

Market data is dynamically constructed from the Emissions Market Information Data Processing System 1905. The system 100 analyzes the applicable time periods associated with given market projections and make comparisons with similar generated value datasets described hereafter.

The Emissions Market Information Data Processing System 1905 calculates and correlates market data prices maintained within the Market Pricing Subsystem 1916 for a plurality of different time periods maintained in the Market Targeting Information Subsystem 1915 by comparing, analyzing, and structuring said projections into datasets of like time periods. The Emissions Market Information Data Processing System 1905 correlates these constructed datasets with a plurality of dataset to be compared against.

The emissions management activity data for a given enterprise entity does not necessarily have to be owned directly by that entity but may be owned by subordinate entities. Due to the architecture of the system 100, all activity data retrieved will be revaluated to reflect the complete enterprise structure, percent ownerships, and ownership rules system to which the percent ownerships of the activity are adjusted for any given time period. In addition, the time periods for a given year for a given activity may not match the time periods for other activities or the time period for the emissions and enterprise structure data. The architecture of the system 100 analyzes, correlates, and aggregates these time periods into a common time period for similar types of data by correlating data of lesser detailed time periods with the last applicable relational time period of the more detailed time period or by correlating more detailed time period data with encompassing lesser detailed time period data.

Different emissions management activities may consist of different combinations of emission focuses. The different emissions that can be recorded in the system have different common product equivalencies and will be revaluated to ensure data consistency. In addition, the system 100 can promulgate different future emissions management activity scenarios to generate and compare projected ‘business as usual’ projections as well as different ‘what if’ scenarios to assist users of the system 100 to analyze potential futures for the said entity. Combined with historic and potential emissions reduction unit transaction at fixed prices, the emissions reduction units generated by said activities have direct impacts on the financial assessments of those activities.

The Emissions Management Activities Data Processing System 1808 constructs the historic and projected costs and revenues associated with given activities. The Activity Financial Subsystem 1830 generates and compares costs and revenues for individual time periods maintained by the Activity Record Period Subsystem 1828 into totals for user or system selected time periods. These datasets are constrained by the selection boundaries and types provided by the Activities Legalities and Location Subsystem 1824 which instructs the subsystems activity ownership percentages for each given activity.

The Activity Units Transaction Distribution Subsystem 1827 correlates transacted emissions reduction units with the Activity Financial Subsystem 1830 to determine fixed price revenues that are aggregated with the other revenues calculated from the Activity Financial Subsystem 1830. Any fixed prices for generated emissions reduction units are correlated with the Activity Historic ERU Details Subsystem 1825 and the Activity Projected ERU Details Subsystem 1825 to generate fixed price costs that are aggregated with other costs generated by the Activity Financial Subsystem 1830. As the data is constructed, each individual record set is filtered through the Entity Ownership Subsystems 1821 of the Non-Emissions Entity Data Processing System 1803 where the data is analyzed, transformed and revalued to reflect all ownership percentages and rule sets at each enterprise level for the respective individual time periods.

The Activity Rates Subsystem 1829 maintains and manages financial rate data for a given activity. These financial rates include but are not limited to discount rates, user-defined risk rates, internal rate of return upper and lower bounds, and time value of money rates. These datasets are used within the Activity Financial Subsystem 1830 to generate discounted, risk-adjusted, and time value of money adjusted cost and revenue data sets.

The Activity Risk Assessment Subsystem 1831 maintains and manages activity risk data for a given emissions management activity record. This risk information includes informational data, including probabilities and impact values on financial and emissions reductions unit risks. The Activity Risk Assessment Subsystem 1831 uses these data sets to create Financial Risk Rates and Financial Values at Risk for a given activity where as the Activity Financial Subsystem 1830 calculates system generated risk adjusted cost and revenue values.

The Emissions Management. Activities Data Processing System 1808 constructs the historic reduction unit datasets one time period at a time. Within this system, the Activity Historic ERU Details Subsystem 1825 locates all the correct data for each individual emission and emissions types and for each time period and for each user or system selected activity. These datasets are constrained by the selection boundaries and types provided by the Activities Legalities and Location Subsystem 1824 and by the Activity Record Period Subsystem 1828 which instructs the subsystem on the correct time periods that the data is applicable. As the data is constructed, each individual record set is filtered through the Entity Ownership Subsystems 1821 of the Non-Emissions Entity Data Processing System 1803 where the data is analyzed, transformed and revalued to reflect all ownership percentages and rule sets at each enterprise level for the respective individual time periods. The Activity Record Period Subsystem 1828 maintains different associated time periods for the records associated with the management activities and the records associated with the Entity Ownership Subsystems 1821, by controlling the conversions and decision of paths to promulgate the datasets through the same time period. Each data piece is converted to a weighted equivalent via the Emissions Conversion Factors Subsystem 1809 of the Administration Data Processing System 1800. The Activity Units Transaction Distribution Subsystem 1827 constructs a-complete set of annualized reduction units that have a different distribution path and adjust the reduction unit datasets accordingly.

The Emissions Management Activities Data Processing System 1808 constructs the projected reduction unit datasets for any user or system instructed future years. Within this system, the Activity Projected ERU Details Subsystem 1825 selects, compares, and aggregates all the correct data one time period at a time from the scenario datasets specified as the ‘default’ datasets or if instructed, from other ‘what if’ datasets for each user or system selected activity. These datasets are constrained by the selection boundaries and types instructed by the Activities Legalities and Location Subsystem 1824 and by the Activity Record Period Subsystem 1828 which instructs the subsystem on the correct time periods that the data is applicable. As the data is constructed, each individual record set is filtered through the Entity Ownership Subsystems 1821 of the Non-Emissions Entity Data Processing System 1803 where the data is transformed and revalued to reflect all ownership percentages and rule sets at each enterprise level for the respective individual time periods. Each data record set for emissions that have a common weight standard is converted to a weighted equivalent via the Emissions Conversion Factors Subsystem 1809 of the Administration Data Processing System 1803. The Activity Units Transaction Distribution Subsystem 1827 constructs a complete set of annualized reduction units that have a different distribution path and adjust the reduction unit datasets accordingly.

The Reports Generator Data Processing Systems 1802 combines the multitude of datasets constructed by the Emissions Inventory Data Processing System 1804 and the Emissions Management Activities Data Processing System 1808 into a plurality of Emissions Management Portfolio/Activity Within the Context of the Marketplace 1801.

All datasets are compared, filtered and formatted by the System Regulations Subsystem 1811 of the Administration Data Processing System 1803 to properly characterize the data according to user set metrics and measurements. The reports and visual outputs are generated on a number of levels to present financial assessments including, but not limited to, annualized costs and revenues compared against market projection data over time, including monthly, quarterly, or annual intervals where costs and revenues can be discounted, risk adjusted, or adjusted against the time value of money; future costs and revenues compared against market projections over time reflecting different ‘what if’ scenarios for specific emissions or for the total of all emissions combined using common weight equivalencies where costs and revenues can be discounted, risk adjusted, or adjusted against the time value of money; activity and portfolio values calculated by subtracting generated costs from generated revenues compared against market projection data over time including monthly, quarterly, or annual intervals where costs and revenues can be discounted, risk adjusted, or adjusted against the time value of money; where all the preceding report types are based on current and historic enterprise ownership structures or projected future enterprise ownership structures; and prospective net emissions over time in relation to potential prospective and/or divested activities. The report display types generated by the Reports Generator Data Processing Systems 1802 include, but are not limited to, visual outputs such as textual outputs and table formats, pie graphs, bar charts, line graphs, or a combination thereof.

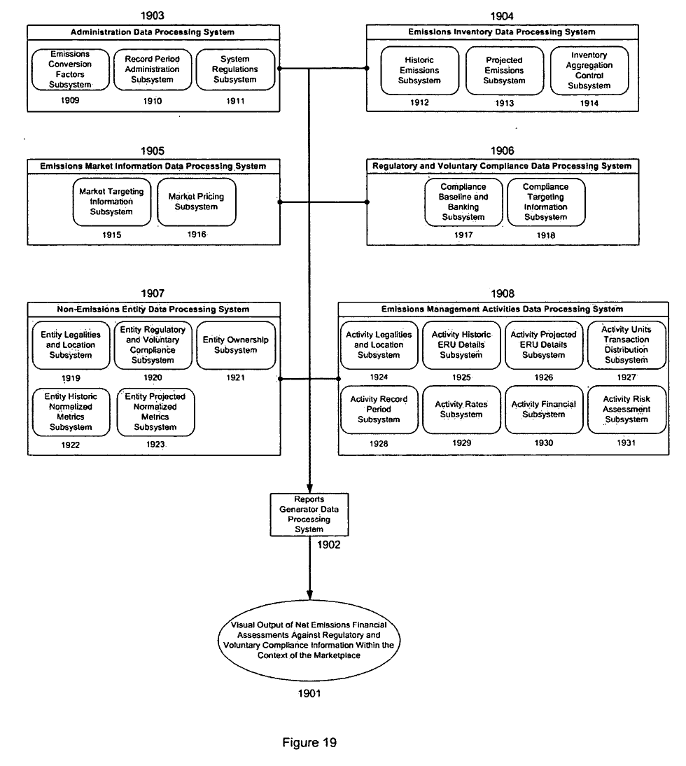

Referring to FIG. 19, this block diagram illustrates the methods and systems that function in the plurality of query operations to examine normalized or absolute net emissions financial assessments against regulatory or voluntary environmental program goals within the context of the market place that may be executed by an embodiment of the system 100 for a given enterprise entity which consists of an entity, subsidiary, joint venture, facility, process, and the like, or a combination thereof. These plurality of query operations for Net Emissions Financial Assessments Against Regulatory and Voluntary Compliance Information Within the Context of the Marketplace 1901 generated by the Reports Generator Data Processing System 1902 that may be executed by an embodiment of the system 100 are useful for determining the cost-effectiveness or asset positions of a portfolio or an individual activity for any entity, subsidiary, joint venture, facility, process, and the like, or a combination thereof, taking into account financial performance and market prices and future price projections, as well as regulatory and voluntary compliance data, which could be necessary, in some instances, for determining economically-viable program plans and activities.

The pluralities of query operations performed by the Reports Generator Data Processing System 1902 include, but are not limited to, the systems and subsystems described hereafter. Unless stated, the following methods are not necessarily performed in any particular order.

Market data is dynamically constructed from the Emissions Market Information Data Processing System 1905. The system 100 will diagnose the applicable time periods associated with given market projections and make comparisons with similar generated value datasets described hereafter.

The Emissions Market Information Data Processing System 1905 calculates and correlates market data prices maintained within the Market Pricing Subsystem 1916 for a plurality of different time periods maintained in the Market Targeting Information Subsystem 1915 by comparing, analyzing, and structuring said projections into datasets of like time periods. The Emissions Market Information Data Processing System 1905 correlates these constructed datasets with a plurality of dataset to be compared against.

Regulatory and voluntary environmental program goals are dynamically calculated using the baselines and targets defined in the Regulatory and Voluntary Compliance Data Processing System 1906 and from the enterprise structure of a given enterprise entity for the applicable time periods. The system 100 analyzes the enterprise structure, percent ownerships, and ownership rules system to which the percent ownerships of the activity are adjusted, for the base year(s) and the target year(s) and make a determination on which enterprise levels and at what quantity to aggregate baselines. Multiple baselines are averaged or filtered by minimums or maximums depending on how the environmental program goal was defined. Baselines are adjusted by the reduction percentages for a given environmental program goal.

The banking system incorporated when comparing net emissions against regulatory and voluntary environmental program goals stores and aggregates system or user selected emissions management activity reductions for the years defined for a given environmental program goal and applies the totals to the net inventory at the defined compliance goal target year.

The Regulatory and Voluntary Compliance Data Processing System 1906 instructs the Historic Emissions Subsystem 1912 on constructing baseline emission positions using defined baseline data in the Compliance Baseline and Banking System 1917 for a given enterprise entity. The Historic Emissions Subsystem 1912 locates and analyzes all the correct data for each individual emission and emissions type for the time periods applicable to the baseline(s) for the given environmental program goal. This selection process is instructed by the Inventory Aggregation Control Subsystem 1914 and the Record Period Administration Subsystem 1910 of the Administration Data Processing System 1903 along with the Compliance Baseline and Banking System 1917 by providing the Historic Emissions Subsystem 1912 the correct subordinate level locations to retrieve the datasets from based on factors including, but not limited to, current and past enterprise structures, operational time periods, ownership time periods, and enterprise entity procurement and divesture points. As the data is retrieved, each individual record is filtered through the Entity Ownership Subsystems 1921 of the Non-Emissions Entity Data Processing System 1903 where the data is analyzed, transformed, and revalued to reflect all ownership percentages and rule sets at each enterprise level for each enterprise entity as it is structured in the target year of the compliance goal. Each data record for emissions that have a common weight standard is converted to a weighted equivalent via the Emissions Conversion Factors Subsystem 1909 of the Administration Data Processing System 1903. Multiple baselines are either averaged or filtered by minimum or maximum values depending on set parameters for a given compliance goal.

The emissions data for a given enterprise entity does not necessarily have to be stored in the application datastores but can be created from other subordinate entities and due to the architecture of the system 100, can be dynamically created for monthly, quarterly, annual and other time periods while reflecting the given time periods complete enterprise structure, percent ownerships, and ownership rules system. The ownership percentages for each enterprise entity are adjusted by percent ownership rules sets applied to each enterprise entity and are promulgated up through the different enterprise levels and applied to the different emissions weight values. The different emissions weights that are recorded in the system are also revaluated by multiplying emissions weights by a common product equivalent to ensure a common data consistency between different emissions. The individual emissions weights are aggregated for the given time periods to formulate a total emissions value. In addition, the system 100 can similarly promulgate different future inventory scenarios to generate and compare projected ‘business as usual’ projections as well as different ‘what if’ scenarios to provide information to users of the system 100 with information which analyzes potential futures for the said entity.

The Emissions Inventory Data Processing System 1904 constructs the historic emissions inventory datasets one time period at a time. Within this system, the Historic Emissions Subsystem 1912 locates and compares all the correct data for each individual emission and emissions type for each time period. This selection process is instructed by the Inventory Aggregation Control Subsystem 1914 and the Record Period Administration Subsystem 1910 of the Administration Data Processing System 1903 which provides the Historic Emissions Subsystem 1912 the correct subordinate level locations to retrieve the datasets from and for which time periods that the data is applicable. As the data is retrieved, each individual record is filtered through the Entity Ownership Subsystems 1921 of the Non-Emissions Entity Data Processing System 1903 where the data is transformed and revalued to reflect all ownership percentages and rule sets at each enterprise level for the respective individual time periods. Each data record for emissions that have a common weight standard is converted to a weighted equivalent via the Emissions Conversion Factors Subsystem 1909 of the Administration Data Processing System 1903.

The Emissions Inventory Data Processing System 1904 constructs the projected emissions inventory datasets for user or system instructed future years. Within this system, the Projected Emissions Subsystem 1913 selects, compares, and aggregates all the correct data one time period at a time from the scenario datasets specified as the ‘default’ datasets or if instructed, from other ‘what if’ datasets. This selection process is driven by the Inventory Aggregation Control Subsystem 1914 and the Record Period Administration Subsystem 1910 of the Administration Data Processing System 1903 which provides the Projected Emissions Subsystem 1913 the correct subordinate level locations, based on the previous year's last known enterprise structure, to retrieve the datasets from. As the data is retrieved, each individual record set is filtered through the Entity Ownership Subsystems 1921 of the Non-Emissions Entity Data Processing System 1903 where the data is transformed and revalued to reflect all ownership percentages and rule sets at each enterprise level for the respective individual time periods. Each data record set for emissions that have a common weight standard is converted to a weighted equivalent via the Emissions Conversion Factors Subsystem 1909 of the Administration Data Processing System 1903.

The emissions management activity data for a given enterprise entity does not necessarily have to be owned directly by that entity but may be owned by subordinate entities. Due to the architecture of the system 100, all activity data retrieved will be revaluated to reflect the complete enterprise structure, percent ownerships, and ownership rules system to which the percent ownerships of the activity are adjusted for any given time period. In addition, the time periods for a given year for a given activity may not match the time periods for other activities or the time period for the emissions and enterprise structure data. The architecture of the system 100 correlates and aggregates these time periods into a common time period for similar types of data by correlating data of lesser detailed time periods with the last applicable relational time period of the more detailed time period or by correlating more detailed time period data with encompassing lesser detailed time period data.

Different emissions management activities may consist of different combinations of emission focuses. The different emissions that can be recorded in the system have different common product equivalencies and will be revaluated to ensure data consistency. In addition, the system 100 can promulgate different future emissions management activity scenarios to generate and compare projected ‘business as usual’ projections as well as different ‘what if’ scenarios to provide users of the system 100 with information which analyzes potential futures for the said entity.

The Emissions Management Activities Data Processing System 1908 constructs the historic reduction unit datasets one time period at a time. Within this system, the Activity Historic ERU Details Subsystem 1925 locates all the correct data for each individual emission and emissions types and for each time period and for each user or system selected activity. These datasets are constrained by the selection boundaries and types provided by the Activities Legalities and Location Subsystem 1924 and by the Activity Record Period Subsystem 1928 which instructs the subsystem on the correct time periods that the data is applicable. As the data is constructed, each individual record set is filtered through the Entity Ownership Subsystems 1921 of the Non-Emissions Entity Data Processing System 1903 where the data is analyzed, transformed, and revalued to reflect all ownership percentages and rule sets at each enterprise level for the respective individual time periods. The Activity Record Period Subsystem 1928 maintains different associated time periods for the records associated with the management activities and the records associated with the Entity Ownership Subsystems 1921, by controlling the conversions and decision of paths to promulgate the datasets through the same time period. All activity emissions reduction units are analyzed against the Regulatory and Voluntary Compliance Data Processing System 1906 to determine if they are ‘bankable’. If so, the given emission reduction units are not applied to the given time period they were generated from, but to the target year of the said environmental program goal. Each data piece is converted to a weighted equivalent via the Emissions Conversion Factors Subsystem 1909 of the Administration Data Processing System 1900. The Activity Units Transaction Distribution Subsystem 1927 constructs a complete set of annualized reduction units that have a different distribution path and adjust the reduction unit datasets accordingly.

The Emissions Management Activities Data Processing System 1908 constructs the projected reduction unit datasets for any user or system instructed future years. Within this system, the Activity Projected ERU Details Subsystem 1925 selects and aggregates all the correct data one time period at a time from the scenario datasets specified as the ‘default’ datasets or if instructed, from other ‘what if’ datasets for each user or system selected activity. These datasets are constrained by the selection boundaries and types instructed by the Activities Legalities and Location Subsystem 1924 and by the Activity Record Period Subsystem 1928 which instructs the subsystem on the correct time periods that the data is applicable. As the data is constructed, each individual record set is filtered through the Entity Ownership Subsystems 1921 of the Non-Emissions Entity Data Processing System 1903 where the data is transformed and revalued to reflect all ownership percentages and rule sets at each enterprise level for the respective individual time periods. All activity emissions reduction units are analyzed against the Regulatory and Voluntary Compliance Data Processing System 1906 to determine if they are ‘bankable’. If so, the given emission reduction units are not applied to the given time period they were generated from, but to the target year of the said environmental program goal. Each data record set for emissions that have a common weight standard is converted to a weighted equivalent via the Emissions Conversion Factors Subsystem 1909 of the Administration Data Processing System 1903. The Activity Units Transaction Distribution Subsystem 1927 constructs a complete set of annualized reduction units that have a different distribution path and adjusts the reduction unit datasets accordingly.

The different metrics that can be recorded in the system 100 can be used to normalize historic and future emissions and net emissions positions. Types of these normalized metrics include, but are not limited to, gross revenue, net revenue, and product yield metrics. The system 100 can promulgate different future normalized metric scenarios to generate and compare projected ‘business as usual’ projections as well as different ‘what if’ scenarios to provide users of the system 100 with information which analyzes potential normalized emission and net emission positions. For example, displaying emissions data in metric tonnes per US dollar.

The Non-Emissions Entity Data Processing System 1907 constructs the historic normalized metric datasets one time period at a time. Within this system, the Entity Historic Normalized Metric Subsystem 1922 locates all the correct data for the given enterprise level for each time period. This selection process is instructed by the Record Period Administration Subsystem 1910 of the Administration Data Processing System 1903 which provides the Entity Historic Normalized Metric Subsystem 1922 the time periods that the data is applicable.

The Emissions Non-Emissions Entity Data Processing System 1907 constructs the projected emissions inventory datasets for user or system instructed future years. Within this system, the Entity Projected Normalized Metrics Subsystem 1923 selects all the correct data one time period at a time from the scenario datasets specified as the ‘default’ datasets or if instructed, from other ‘what if’ datasets.

The Reports Generator Data Processing Systems 1902 combines the multitude of datasets constructed by the Emissions Market Information Data Processing System 1905, the Emissions Inventory Data Processing System 1904, the Emissions Management Activities Data Processing System 1908 and the Emissions Non-Emissions Entity Data Processing System 1907, and the Voluntary Compliance Data Processing System 1906 into a plurality of normalized and absolute net emissions inventory positions 1901 comparisons with environmental program goals within the context of the market place.

All datasets are filtered and formatted by the System Regulations Subsystem 1911 of the Administration Data Processing System 1903 to properly characterize the data according to user set metrics and measurements. The reports and visual outputs are generated on a number of levels to present net emission positions versus environmental program goals within the context of the market place including, but not limited to, net emission reduction inventories versus environmental program goals showing probable incurred market driven costs; normalized net emission reduction inventories versus environmental program goals showing probable incurred market driven costs; annualized net emissions gap analysis versus environmental program goals showing probable incurred market driven costs; annualized normalized net emissions gap analysis versus environmental program goals showing probable incurred market driven costs; where all the preceding report types are based on current enterprise ownership structures or projected future enterprise ownership structures; prospective net emissions over time in relation to potential prospective and/or divested activities; and net emissions over time in relation to user or system distributed bankable emissions reductions for given time periods; different prospective or real time market projections. The report display types generated by the Reports Generator Data Processing Systems 1902 include, but are not limited to, visual outputs such as textual outputs and table formats, pie graphs, bar charts, line graphs, or a combination thereof.

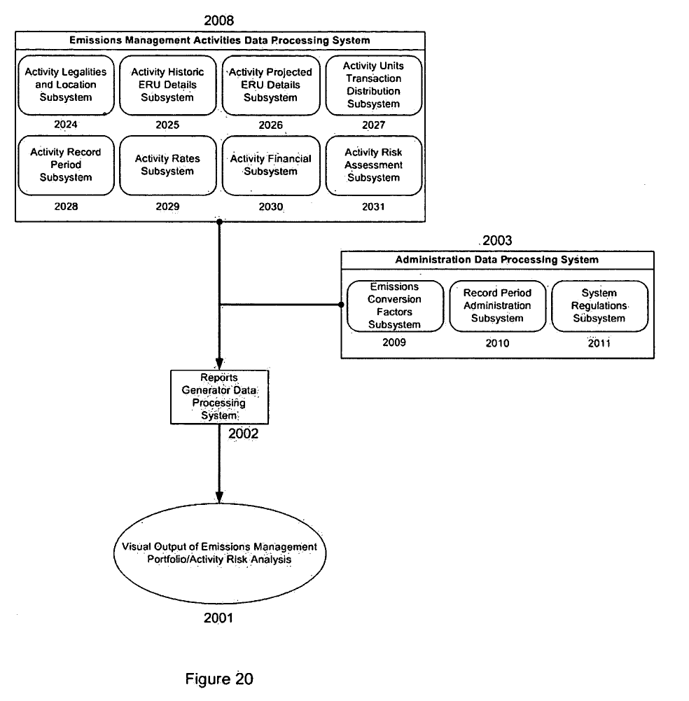

Referring to FIG. 20, this block diagram illustrates the methods and systems that function in the plurality of query operations to examine emissions management portfolio/activity risk analysis that may be executed by an embodiment of the system 100 for a given enterprise entity which consists of an entity, subsidiary, joint venture, facility, process, and the like, or a combination thereof. These plurality of query operations for Emissions Management Portfolio/Activity Risk Analysis 2001 generated by the Reports Generator Data Processing System 2002 that may be executed by an embodiment of the system 100 are useful for determining the risk positions of a portfolio or an individual activity for any entity, subsidiary, joint venture, facility, process, and other such activities, or a combination thereof, taking into selected risk factors and data, which could be necessary, in some instances, for determining program plans and activities.

The pluralities of query operations performed by the Reports Generator Data Processing System 2002 include, but are not limited to, the systems and subsystems described hereafter. Unless stated, the following methods are not necessarily performed in any particular order.

The emissions management activity data for a given enterprise entity does not necessarily have to be owned directly by that entity but may be owned by subordinate entities. Due to the architecture of the system 100, all activity data retrieved will be revaluated to reflect the complete enterprise structure, percent ownerships, and ownership rules system to which the percent ownerships of the activity are adjusted for any given time period. In addition, the time periods for a given year for a given activity may not match the time periods for other activities or the time period for the emissions and enterprise structure data. The architecture of the system 100 analyzes, correlates, and aggregates these time periods into a common time period for similar types of data by correlating data of lesser detailed time periods with the last applicable relational time period of the more detailed time period or by correlating more detailed time period data with encompassing lesser detailed time period data.

Different emissions management activities may consist of different combinations of emission focuses. The different emissions that can be recorded in the system have different common product equivalencies and will be revaluated to ensure data consistency. In addition, the system 100 can promulgate different future emissions management activity scenarios to generate and compare projected ‘business as usual’ projections as well as different ‘what if’ scenarios to provide users of the system 100 with information which analyzes potential futures for the said entity. Combined with historic and potential emissions reduction unit transaction at fixed prices, the emissions reduction units generated by said activities have direct impacts on the financial assessments of those activities.

The Activity Risk Assessment Subsystem 2031 maintains and manages activity risk data for a given emissions management activity record. This risk information includes informational data, including probabilities and impact values on financial and emissions reductions unit risks. The Activity Risk Assessment Subsystem 2031 uses these data sets to create Financial Risk Rates, Financial Values at Risk, Emissions Reductions Risk Rates, and Emissions Volumes Values at Risk for a given activity.

The Emissions Management Activities Data Processing System 2008 constructs the historic and projected costs and revenues associated with given activities. The Activity Financial Subsystem 2030 generates and compares costs and revenues for individual time periods maintained by the Activity Record Period Subsystem 2028 into totals for user or system selected time periods. These datasets are constrained by the selection boundaries and types provided by the Activities Legalities and Location Subsystem 2024 which instructs the subsystems activity ownership percentages for each given activity.

The Activity Units Transaction Distribution Subsystem 2027 correlates transacted emissions reduction units with the Activity Financial Subsystem 2030 to determine fixed price revenues that are aggregated with the other revenues calculated from the Activity Financial Subsystem 2030. Any fixed prices for generated emissions reduction units are correlated with the Activity Historic ERU Details Subsystem 2025 and the Activity Projected ERU Details Subsystem 2025 to generate fixed price costs that are aggregated with other costs generated by the Activity Financial Subsystem 2030. As the data is constructed, each individual record set is filtered through the Entity Ownership Subsystems 2021 of the Non-Emissions Entity Data Processing System 2003 where the data is analyzed, transformed and revalued to reflect all ownership percentages and rule sets at each enterprise level for the respective individual time periods.

The Emissions Management Activities Data Processing System 2008 constructs the historic reduction unit datasets one time period at a time. Within this system, the Activity Historic ERU Details Subsystem 2025 locates all the correct data for each individual emission and emissions types and for each time period and for each user or system selected activity. These datasets are constrained by the selection boundaries and types provided by the Activities Legalities and Location Subsystem 2024 and by the Activity Record Period Subsystem 2028 which instructs the subsystem on the correct time periods that the data is applicable. As the data is constructed, each individual record set is filtered through the Entity Ownership Subsystems 2021 of the Non-Emissions Entity Data Processing System 2003 where the data is analyzed, transformed and revalued to reflect all ownership percentages and rule sets at each enterprise level for the respective individual time periods. The Activity Record Period Subsystem 2028 maintains different associated time periods for the records associated with the management activities and the records associated with the Entity Ownership Subsystems 2021, by controlling the conversions and decision of paths to promulgate the datasets through the same time period. Each data piece is converted to a weighted equivalent via the Emissions Conversion Factors Subsystem 2009 of the Administration Data Processing System 2000. The Activity Units Transaction Distribution Subsystem 2027 constructs a complete set of annualized reduction units that have a different distribution path and adjusts the reduction unit datasets accordingly.

The Emissions Management Activities Data Processing System 2008 constructs the projected reduction unit datasets for any user or system instructed future years. Within this system, the Activity Projected ERU Details Subsystem 2025 selects, compares, and aggregates all the correct data one time period at a time from the scenario datasets specified as the ‘default’ datasets or if instructed, from other ‘what if’ datasets for each user or system selected activity. These datasets are constrained by the selection boundaries and types instructed by the Activities Legalities and Location Subsystem 2024 and by the Activity Record Period Subsystem 2028 which instructs the subsystem on the correct time periods that the data is applicable. As the data is constructed, each individual record set is filtered through the Entity Ownership Subsystems 2021 of the Non-Emissions Entity Data Processing System 2003 where the data is transformed and revalued to reflect all ownership percentages and rule sets at each enterprise level for the respective individual time periods. Each data record set for emissions that have a common weight standard is converted to a weighted equivalent via the Emissions Conversion Factors Subsystem 2009 of the Administration Data Processing System 2003. The Activity Units Transaction Distribution Subsystem 2027 constructs a complete set of annualized reduction units that have a different distribution path and adjust the reduction unit datasets accordingly.

The Reports Generator Data Processing Systems 2002 combines the multitude of datasets constructed by the Emissions Inventory Data Processing System 2004 and the Emissions Management Activities Data Processing System 2008 into a plurality of Emissions Management Portfolio/Activity Within the Context of the Marketplace 2001.

All datasets are compared, filtered and formatted by the System Regulations Subsystem 2011 of the Administration Data Processing System 2003 to properly characterize the data according to user set metrics and measurements.

The displayed reports and visual outputs are generated on a number of levels to present risk assessments and analysis including, but not limited to, time period specific risk adjusted cost and revenue values for a given activity/portfolio where time periods include monthly, quarterly, annual and other periods; financial values at risk for a given activity; mean financial value at risk for a given portfolio; activity and portfolio risk rates; total financial values at risk for a given portfolio; portfolio and activity risk rates; emission reduction units at risk for a given activity, mean emissions reduction units at risk for a given portfolio, total emissions reduction units at risk for a given portfolio; and risk adjusted cost and revenue values per unit of emissions reductions for a given activity/portfolio; expected net present value for a single or specific risk type or groups or risk types; expected financial loss given a specific risk type; required rate of return for a specific risk type; expected total emissions reduction given a specific emissions risk type; expected emissions loss given a specific emissions risk type; required rate of return to off-set a given risk type. The displayed reports generated by the Reports Generator Data Processing Systems 2002 include, but are not limited to, visual outputs such as textual outputs and table formats, pie graphs, bar charts, line graphs, or a combination thereof.

Environment

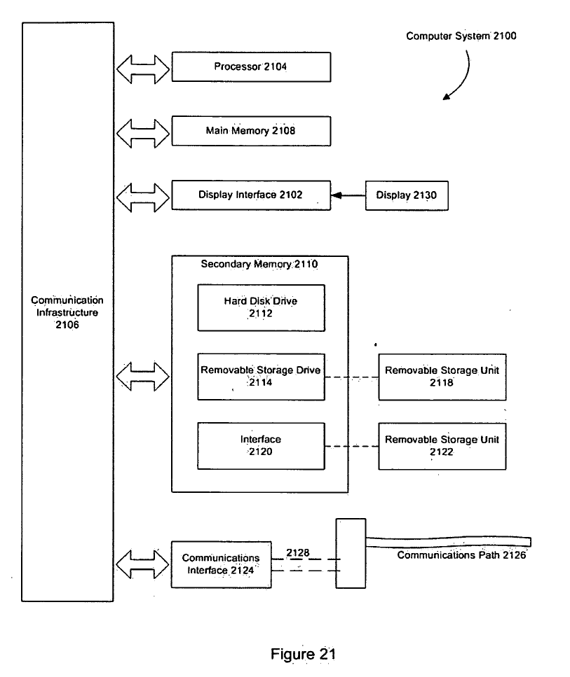

The functions of the present invention (i.e. cataloging, management, and planning system 100 or any part thereof) may be implemented using standard hardware, software, or a combination thereof and may be implemented in a computer system or other processing system. In fact, in one embodiment, the invention is directed toward one or more standard computer systems capable of carrying out the functionality described herein. An example of a computer system 2100 is shown in FIG. 21. The computer system 2100 includes one or more processors, such as processor 2104. The processor 2104 is connected to a communication infrastructure 2106 (e.g., a communications bus, cross-over bar, or network). Various software embodiments are described in terms of this exemplary computer system. After reading this description, it will be apparent to a person skilled in the relevant art(s) how to implement the invention using other standard computer systems and/or computer architectures.

Computer system 2100 can include a display interface 2105 that forwards graphics, text, and other data from the communication infrastructure 2102 (or from a frame buffer not shown) for display on the display unit 2130.

Computer system 2100 also-includes a main memory 2108, preferably random access memory (RAM), and may also include a secondary memory 2110. The secondary memory 2110 may include, for example, a hard disk drive 2112 and/or a removable storage drive 2114, representing a floppy disk drive, a magnetic tape drive, an optical disk drive, etc. The removable storage drive 2114 reads from and/or writes to a removable storage unit 2118 in a well-known manner. Removable storage unit 2118, represents a floppy disk, magnetic tape, optical disk, etc. which is read by and written to by removable storage drive 2114. As will be appreciated, the removable storage unit 2118 includes a computer usable storage medium having stored therein computer software and/or data.

In alternative embodiments, secondary memory 2110 may include other similar means for allowing computer programs or other instructions to be loaded into computer system 2100. Such means may include, for example, a removable storage unit 2122 and an interface 2120. Examples of such may include a program cartridge and cartridge interface (such as that found in video game devices), a removable memory chip (such as an EPROM, or PROM) and associated socket, and other removable storage units 2122 and interfaces 2120 which allow software and data to be transferred from the removable storage unit 2122 to computer system 2100.

Computer system 2100 may also include a communications interface 2124. Communications interface 2124 allows software and data to be transferred between computer system 2100 and external devices. Examples of communications interface 2124 may include a modem, a network interface (such as an Ethernet card), a communications port, a PCMCIA slot and card, etc. Software and data transferred via communications interface 2024 are in the form of signals 2128 which may be electronic, electromagnetic, optical, or other signals capable of being received by communications interface 2124. These signals 2128 are provided to communications interface 2124 via a communications path (i.e., channel) 2126. This channel 2126 carries signals 2128 and may be implemented using wire and cable, fiber optics, a phone line, a cellular phone link, a RF link, and other communications channels.

In this document, the terms “computer-readable medium” and “computer-usable medium” are used to generally refer to any kind of computer memory such as floppy disks, conventional hard disks, CD-ROMS, Flash ROMS, nonvolatile ROM and RAM. These computer mediums are means for providing software instructions to the computer system 2100 by which it performs the method functions. An embodiment of this invention is directed to such computer software products.

Computer programs (also called computer control logic) are stored in main memory 2108 and/or secondary memory 2110. Computer programs may also be received via communications interface 2124. Such computer programs, when executed, enable the computer system 2100 to perform the functions of the present invention as discussed herein. In particular, the computer programs, when executed, enable the processor 2104 to perform the functions of the present invention. Accordingly, such computer programs represent controllers of the computer system 2100.

In an embodiment where the invention is implemented using software, the software may be stored in a computer product and loaded into computer system 2100 using removable storage 2114, hard drive 2112, or communications interface 2124. The control logic (software), when executed by the processor 2104, causes the processor 2104 to perform the functions of the invention as described herein.

In another embodiment, the invention is primarily in hardware using, for example, hardware components such as application specific integrated circuit chips (ASICs). Implementation of the hardware state machine so as to perform the functions described herein will be apparent to persons skilled in the relevant art(s).

In yet another embodiment, the method invention is implemented using a combination of both hardware and software.

While various embodiments of the present invention have been described above, it should be understood that they have been presented by way of example, and not limitation. It will be apparent to persons skilled in the relevant art(s) that various changes in form and detail may be made therein without departing from the scope of the invention. This is especially true in light of technology and terms within the relevant art(s) that may be later developed. Thus, the present invention should not be limited by any of the above-described exemplary embodiments, but should only be defined only in accordance with the associated claims and their equivalents.

We claim:

1) A computerized method for managing enterprise environmental programs, said method comprised of the steps of:
a) entering into a computerized system data sets of enterprise ownership relationships and of environmental emissions information from entities within the enterprise, for one or more time periods;
b) analyzing said data sets;
c) generating comparisons among said data sets; and,
d) providing a visual output of said comparisons;
wherein the step of analyzing the data sets includes the attribution of environmental emissions data to multiple entities within a multi-layered enterprise hierarchy.

2) The computerized method of claim 1, wherein the data sets include projections of future enterprise ownership relationships.

3) The computerized method of claim 1, wherein the step of analyzing the data includes the determination of projections of future emissions and attribution of said future emissions to multiple entities within the enterprise hierarchy.

4) The computerized method of claim 1, wherein the data sets include time periods of varying duration.

5) The computerized method of claim 1, wherein the data sets include financial information.

6) The computerized method of claim 1, wherein the data sets include environmental program goals.

7) The computerized method of claim 6, wherein the comparisons generated include multiple concurrent and independent environmental program goals.

8) A computerized method for managing enterprise environmental programs, said method comprised of the steps of:
a) entering into a computerized system data sets of enterprise ownership relationships and of environmental emissions information from entities within the enterprise, for one or more time periods;
b) analyzing said data sets;
c) generating comparisons among said data sets; and,
d) providing a visual output of said comparisons;
wherein, the data sets entered into the computerized data base include time periods of varying duration.

9) The computerized method of claim 8, wherein the data sets include environmental program goals.

10) The computerized method of claim 8, wherein the data sets include financial information.

11) The computerized method of claim 8, wherein the steps of analysis and generating comparisons include multiple entities within a multi-layered enterprise hierarchy.

12) A computerized method for managing enterprise environmental programs, said method comprised of the steps of:
a) entering into a computerized system data sets of enterprise ownership relationships, of environmental emissions information from entities within the enterprise, and of environmental program goals, for one or more time periods;
b) analyzing said data sets;
c) generating comparisons among said data sets; and
d) providing a visual output of said comparisons;
wherein the comparisons include concurrent comparisons of one or more emissions against multiple environmental program goals.

13) The computerized method of claim 12, wherein said comparisons of emissions against multiple environmental program goals are based on historical emissions.

14) The computerized method of claim 12, wherein said generated comparisons of environmental emissions against multiple environmental program goals include projections of future environmental emissions estimates.

15) The computerized method of claim 12, wherein the generated comparisons of environmental emissions against multiple environmental program goals are attributed to entities within a multi-layered enterprise hierarchy.

16) The computerized method of claim 12, wherein the data sets include financial information.

17) A computerized method for managing enterprise environmental programs, said method comprised of the steps of:
a) entering into a computerized system data sets of enterprise ownership relationships, of environmental emissions information from entities within the enterprise, and of financial information, including information on environmentally related activities, for one or more time periods;
b) analyzing said data sets;
c) generating comparisons among said data sets; and
d) providing a visual output of said comparisons.

18) The computerized method of claim 17, wherein the data sets include environmental program goals.

19) The computerized method of claim 17, wherein financial feasibility metrics for environmentally-related activities are determined.

20) The computerized method of claim 19, wherein the financial feasibility metrics are discounted to present value.

21) The computerized method of claim 19, wherein the financial feasibility metrics are adjusted for the time value of money.

22) The computerized method of claim 19, wherein the financial feasibility metrics include merits of worth.

23) The computerized method of claim 17, wherein the data sets include risk factors and wherein risk-adjusted financial feasibility metrics for environmentally-related activities are determined.

24) The computerized method of claim 17, where the comparisons generated include the cost and revenue projections of an environmentally related activity.

25) The computerized method of claims 1, 8, 12 or 17, wherein the data sets include emissions trading market data and projected emissions trading market data.

26) The computerized method of claim 17 or claim 22, wherein the steps of analysis and generating comparisons use emissions trading market data and emissions trading market projections data.

27) The computerized method of claim 26, wherein the comparisons generated include the value of emissions reduction units for a selected set of environmentally related activities.

28) The computerized method of claim 25, wherein the comparisons generated include the value of emissions reduction units for a selected set of environmentally related activities.

29) The computerized method of claim 28, wherein the value of projected emissions reduction units are adjusted for risk.

30) The computerized method of claim 28, wherein the value of projected emissions reduction units are discounted.

31) The computerized method of claim 28, wherein the value of actual emissions reduction units are adjusted for the time value of money.

32) The computerized method of claims 1, 8, 12 or 17, wherein the data sets are normalized.

33) The computerized method of claim 32, wherein the comparisons generated and the visual output provided are normalized.

34) A computerized method for managing enterprise environmental programs, said method comprised of the steps of:
a) entering into a computerized system data sets of enterprise ownership relationships, of environmental emissions information from entities within the enterprise, and of financial information, for one or more time periods;
b) analyzing said data sets;
c) generating comparisons among said data sets; and
d) providing a visual output of said comparisons;
wherein the data sets include data on historic or projected environmentally-related activity transactions, including actual or projected, respectively, emissions reduction units.

35) The computerized method of claim 34, wherein the data sets include environmental program goals.

36) The computerized method of claim 34, wherein the step of analysis determines the cost and revenue values for historic or projected environmentally related transactions.

37) The computerized method of claim 36, wherein the cost and revenue values for historic environmentally related transactions are adjusted for the time value of money.

38) The computerized method of claim 36, wherein the cost and revenue values for projected environmentally related transactions are discounted or are adjusted for risk.

39) The computerized method of claim 34, wherein the comparisons generated include the financial values of a plurality of scenarios of acquisition and divestiture of environmentally-related activities.

40) The computerized method of claim 39, wherein the financial values of the scenarios based on projected emissions reduction units are discounted or are adjusted for risk.

41) The computerized method of claim 39, wherein the financial values of the scenarios based on actual emission reduction units are adjusted for the time value of money.

42) A system for managing enterprise environmental programs, said system comprising the steps:
a) input means for entry of data sets into a computer storage device, said data sets including data on enterprise ownership relationships and of environmental emissions information from entities within the enterprise, for one or more time periods;
b) analysis means, for analyzing said data sets;
c) comparison means, for generating comparisons between the data sets;
d) output means, for generating visual outputs of the results of the comparison means;
wherein the analysis means includes means for attributing environmental emissions data to multiple entities within a multi-layered enterprise hierarchy.

43) The system of claim 42, wherein the data sets entered by the input means include projections of future enterprise ownership relationships.

44) The system of claim 42, wherein the analysis means is comprised of means for determining projections of future emissions and attributing said future emissions to multiple entities within the enterprise hierarchy.

45) The system of claim 42, wherein the data sets entered by the input means include time periods of varying durations.

46) The system of claim 42, wherein the data sets include financial information.

47) The system of claim 42, wherein the data sets include environmental program goals.

48) The system of claim 47, wherein the comparison means is comprised of means to generate comparisons with multiple concurrent and independent environmental program goals.

49) A system for managing enterprise environmental programs, said system comprising the steps:
a) input means for entry of data sets into a computer storage device, said data sets including data on enterprise ownership relationships and of environmental emissions information from entities within the enterprise, for one or more time periods;
b) analysis means, for analyzing said data sets;
c) comparison means, for generating comparisons between the data sets; and,
d) output means, for generating visual outputs of the results of the comparison means;
wherein the data sets entered by the input means is comprised of time periods of varying durations.

50) The system of claim 49, wherein the data sets include environmental program goals.

51) The system of claim 49, wherein the data sets include financial information.

52) The system of claim 49, wherein the analysis means and the comparison means attribute their results to multiple entities within a multi-layered enterprise hierarchy.

53) A system for managing enterprise environmental programs, said system comprising the steps:
a) input means for entry of data sets into a computer storage device, said data sets including data on enterprise ownership relationships, of environmental emissions information from entities within the enterprise and of environmental program goals, for one or more time periods;
b) analysis means, for analyzing said data sets;
c) comparison means, for generating comparisons between the data sets; and,
d) output means, for generating visual outputs of the results of the comparison means;
wherein the comparison means is comprised of means for generating comparisons of one or more environmental emissions concurrently against multiple environmental program goals.

54) The system of claim 53, wherein the comparison means for generating comparisons concurrently against multiple environmental program goals is based on historical environmental emissions.

55) The system of claim 53, wherein the comparison means for generating comparisons concurrently against multiple environmental program goals includes projected future environmental emissions.

56) The system of claim 53, wherein the comparisons generated by the comparison means are attributed to entities within a multi-layered enterprise hierarchy.

57) A system for managing enterprise environmental programs, said system comprising the steps:
a) input means for entry of data sets into a computer storage device, said data sets including data on enterprise ownership relationships, of environmental emissions information from entities within the enterprise and of financial information, including information on environmental activities, for one or more time periods;
b) analysis means, for analyzing said data sets;
c) comparison means, for generating comparisons between the data sets; and,
d) output means, for generating visual outputs of the results of the comparison means.

58) The system of claim 57, wherein the data sets include environmental program goals.

59) The system of claim 57, wherein the analysis means is comprised of means for determining financial feasibility metrics for environmentally-related activities.

60) The system of claim 59, wherein the determined financial feasibility metrics are discounted to present value.

61) The system of claim 59, wherein the determined financial feasibility metrics are adjusted for the time value of money.

62) The system of claim 59, wherein the determined financial feasibility metrics include merits of worth.

63) The system of claim 57, wherein the data sets entered by the input means include risk factors and wherein the analysis means is comprised of means for determining risk adjusted financial feasibility metrics for environmentally-related activities.

64) The system of claim 57, wherein the comparisons generated by the comparison means include the cost and revenue projections of an environmentally-related activity.

65) The system of claims 42, 49, 53 or 57, wherein the data sets entered by the input means include emissions trading market data and emissions trading market projections data.

66) The system of claims 57 or 62, wherein analysis means and the comparison means use emissions trading market data and emissions trading market data projections.

67) The system of claim 66, wherein the comparisons generated by the comparison means include the value of emissions reduction units for a selected set of environmentally-related activities.

68) The system of claim 65, wherein the comparisons generated by the comparison means include the value of actual or projected emissions reduction units for a selected set of environmentally-related activities.

69) The system of claim 68, wherein the value of projected emissions reduction units are adjusted for risk.

70) The system of claim 68, wherein the value of projected emissions reduction units are discounted.

71) The system of claim 68, wherein the value of actual emissions reduction units are adjusted for the time value of money.

72) The system of claims 42, 49, 53 or 57, wherein the analysis means normalizes the data sets.

73) The system of claim 72, wherein the comparisons generated and the visual output provided are normalized.

74) A system for managing enterprise environmental programs, said system comprising the steps:
a) input means for entry of data sets into a computer storage device, said data sets including data on enterprise ownership relationships, of environmental emissions information from entities within the enterprise, and of financial information, for one or more time periods;
b) analysis means, for analyzing said data sets;
c) comparison means, for generating comparisons between the data sets; and,
d) output means, for generating visual outputs of the results of the comparison means;
wherein the data sets are comprised of data on historic or projected environmentally-related activity transactions, including actual or projected, respectively, emissions reduction units.

75) The system of claim 74, wherein the data sets include environmental program goals.

76) The system of claim 74, wherein the analysis means determines the cost and revenue values for historic or projected environmentally-related activity transactions.

77) The system of claim 76, wherein the cost and revenue values for historic environmentally-related activity transactions are adjusted for the time value of money.

78) The system of claim 76, wherein the cost and revenue values for projected environmentally-related activity transactions are discounted or adjusted for risk.

79) The system of claim 74, wherein the comparisons generated include the financial values of a plurality of scenarios of acquisition and divestiture of environmentally-related activities.

80) The system of claim 79, wherein the financial values of the scenarios based on projected emissions reduction units are discounted or adjusted for risk.

81) The system of claim 79, wherein the financial values of the scenarios based on actual emissions reduction units are adjusted for the time value of money.

82) A computer-readable medium having computer-executable instructions for performing a method comprising:
a) entering into a computerized database data sets of enterprise ownership relationships and of environmental emissions information from entities within the enterprise for one or more time periods;
b) analyzing said data sets;
c) generating comparisons among said data sets; and
d) providing a visual output of said comparisons;
wherein the analysis of the data sets includes the attribution of environmental emissions data to multiple entities with a multi-layered enterprise hierarchy.

83) The computer-readable medium of claim 82, wherein the data sets entered into the computerized data base include projections of future enterprise ownership relationships.

84) The computer-readable medium of claim 82, wherein the analysis of the data sets caused by the computer-executable instructions includes the determination of projections of future emissions and attribution of said future emissions to multiple entities within the enterprise hierarchy.

85) The computer-readable medium of claim 82, wherein the data sets entered into the computerized data base include time periods of varying durations.

86) The computer-readable medium of claim 82, wherein the data sets include financial information.

87) The computer-readable method of claim 82, wherein the data sets include environmental program goals.

88) The computer-readable medium of claim 82, wherein the comparisons caused by the computer-executable instructions include multiple concurrent and independent environmental program goals.

89) A computer-readable medium having computer-executable instructions for performing a method comprising:
a) entering into a computerized database data sets of enterprise ownership relationships and of environmental emissions information from entities within the enterprise, for one or more time periods;
b) analyzing said data sets;
c) generating comparisons among said data sets; and,
d) providing a visual output of said comparisons;
wherein, the data sets entered into the computerized database include time periods of varying duration.

90) The computer-readable medium of claim 89, wherein the data sets include environmental program goals.

91) The computer-readable medium of claim 89, wherein the data sets include financial information.

92) The computer-readable medium of claim 89, wherein the analysis and generation of comparisons caused by the computer-executable instructions include multiple entities within a multi-layered enterprise hierarchy.

93) A computer-readable medium having computer-executable instructions for performing a method comprising:
a) entering into a computerized database data sets of enterprise ownership relationships, of environmental emissions information from entities within the enterprise and of environmental program goals, for one or more time periods;
b) analyzing said data sets;
c) generating comparisons among said data sets; and,
d) providing a visual output of said comparisons;
wherein the generation of comparisons caused by the computer-executable instructions include concurrent comparisons of one or more emissions against multiple environmental program goals.

94) The computer-readable medium of claim 93, wherein the comparisons generated by the computer-executable instructions of emissions against multiple environmental program goals are based on historical emissions.

95) The computer-readable medium of claim 93, wherein the comparisons generated by the computer-executable instructions of emissions against multiple environmental program goals are based on projected future emissions estimates.

96) The computer-readable medium of claim 93, wherein the comparisons generated by the computer-executable instructions of emissions against multiple environmental program goals are attributed to entities within a multi-layered enterprise hierarchy.

97) A computer-readable medium having computer-executable instructions for performing a method comprising:
a) entering into a computerized database data sets of enterprise ownership relationships, of environmental emissions information from entities within the enterprise, and of financial information, including financial information on environmentally-related activities, for one or more time periods;
b) analyzing said data sets;
c) generating comparisons among said data sets; and,
d) providing a visual output of said comparisons.

98) The computer-readable medium of claim 97, wherein the data sets include environmental program goals.

99) The computer-readable medium of claim 97, wherein analyzing the data sets includes determining financial feasibility metrics for environmentally-related activities.

100) The computer-readable medium of claim 99, wherein the determined financial feasibility metrics are discounted to present value.

101) The computer-readable medium of claim 99, wherein the determined financial feasibility metrics are adjusted for the time value of money.

102) The computer-readable medium of claim 99, wherein the determined financial feasibility metrics include merits of worth.

103) The computer-readable medium of claim 97, wherein the data sets entered into the computerized database include risk factors, and wherein analyzing the data sets includes determining risk-adjusted financial feasibility metrics for environmentally-related activities.

104) The computer-readable medium of claim 97, wherein the comparisons generated include the cost and revenue projections of environmentally-related activities.

105) The computer-readable medium of claims 82, 89, 93 or 97, wherein the data sets entered into the computerized database include emissions trading market data and projected emission trading market data.

106) The computer-readable medium of claims 97 or 102, wherein analyzing the data sets and generating comparisons use emissions trading market data and projected emissions trading market data.

107) The computer-readable medium of claim 106, wherein the comparisons generated include the value of emissions reduction units for a selected set of environmentally-related activities.

108) The computer-readable medium of claim 105, wherein the comparisons generated include the value of emissions reduction units for a selected set of environmentally-related activities.

109) The computer-readable medium of claim 108, wherein the value of projected emissions reduction units are adjusted for risk.

110) The computer-readable medium of claim 108, wherein the value of projected emissions reduction units are discounted.

111) The computer-readable medium of claim 108, wherein the value of actual emissions reduction units are adjusted for the time value of money.

112) The computer-readable medium of claims 82, 89, 93 or 97, wherein the data sets are normalized.

113) The computer-readable medium of claim 112, wherein the comparisons generated and the visual output provided are normalized.

114) A computer-readable medium having computer-executable instructions for performing a method comprising:
a) entering into a computerized database data sets of enterprise ownership relationships, of environmental emissions information from entities within the enterprise, of environmental program goals, and of financial information, for one or more time periods;
b) analyzing said data sets;
c) generating comparisons among said data sets; and,
d) providing a visual output of said comparisons;
wherein the data sets entered into the computer database include data on historic or projected environmentally-related activity transactions, including actual or projected, respectively, emissions reduction units.

115) The computer-readable medium of claim 114, wherein analyzing the data sets includes determining the cost and revenue values for historic and projected environmentally-related activity transactions, including actual or projected, respectively, emissions reduction units.

116) The computer-readable medium of claim 115, wherein the cost and revenue values of historic environmentally-related activity transactions are adjusted for the time value of money.

117) The computer-readable medium of claim 115, wherein the cost and revenue values for projected environmentally related activities are discounted or are adjusted for risk.

118) The computer-readable medium of claim 114, wherein the comparisons generated include the financial values of a plurality of scenarios of acquisitions and divestiture of environmentally-related activities.

119) The computer-readable medium of claim 118, wherein the values of the projected emissions reduction units are discounted or are adjusted for risk.

120) The computer-readable medium of claim 118, wherein the values of the actual emissions reduction units are adjusted for the time value of money.
